(19) United States
(12) Patent Application Publication
(10) Pub. No.: US 2018/0246493 A1
(43) Pub. Date: Aug. 30, 2018

(54) METHOD OF CREATING A TASK PLAN, INFORMATION PROCESSING APPARATUS AND NON-TRANSITORY COMPUTER-READABLE STORAGE MEDIUM

(71) Applicant: FUJITSU LIMITED, Kawasaki-shi (JP)

(72) Inventors: Jun FUKAO, Ichinomiya (JP); Masanori SAKAI, Nagoya (JP); Yukinori Hayashi, Osaka (JP); Tatsuya ISHIHARA, Yokohama (JP)

(73) Assignee: FUJITSU LIMITED, Kawasaki-shi (JP)

(21) Appl. No.: 15/875,851

(22) Filed: Jan. 19, 2018

(30) Foreign Application Priority Data
Feb. 28, 2017 (JP) 2017-036628

(51) Int. Cl. G05B 19/4063; G06F 9/451

(52) U.S. Cl. CPC G05B 19/4063; G05B 2219/34407; G06F 9/451

(57) ABSTRACT

A method of creating, by a computer, a task plan that prescribes an execution time of a task on which a completion time limit is set, the method includes allocating the execution time of at least one first task in a first period, calculating a first total time length for execution of the at least one first task allocated in the first period, identifying at least one second task that is not allocated in the first period and has the completion time limit set in the first period, calculating a second total time length for execution of the at least one second task, and displaying the first total time length and the second total time length on a display device.

### CROSS-REFERENCE TO RELATED APPLICATION

This application is based upon and claims the benefit of priority of the prior Japanese Patent Application No. 2017-36628, filed on Feb. 28, 2017, the entire contents of which are incorporated herein by reference.

### FIELD

The embodiment discussed herein is related to a method of creating a task plan, an information processing apparatus and a non-transitory computer-readable storage medium.

### BACKGROUND

In a task plan, for example, in a manufacturing plan of a product, the load is visualized by displaying a chart or the like in which tasks are arranged on manufacturing lines by apparatus such as a server based on the vacancy status of the manufacturing lines, the order of task, and so forth. Hereinafter, the “manufacturing line” will be often represented simply as “line.”

For example, when a specific period as the unit of tallying of the load, lines that are used, the condition of the product, parts, or the like are specified by an operator or the like, the server carries out arrangement of the manufacturing plan by allocating the date and time of use of the line to tasks. As related-art documents, Japanese Laid-open Patent Publication No. 06-91495 and Japanese Laid-open Patent Publication No. 04-21003 exist.

### SUMMARY

According to an aspect of the embodiment, a method of creating, by a computer, a task plan that prescribes an execution time of a task on which a completion time limit is set, the method includes allocating the execution time of at least one first task in a first period, calculating a first total time length for execution of the at least one first task allocated in the first period, identifying at least one second task that is not allocated in the first period and has the completion time limit set in the first period, calculating a second total time length for execution of the at least one second task, and displaying the first total time length and the second total time length on a display device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a system according to one embodiment;

FIG. 2 is a block diagram illustrating a hardware configuration example of a server;

FIG. 3 is a diagram illustrating a display example in a display area on a display device;

FIG. 4 is a diagram for explaining a procedure for displaying a chart display setting screen from a screen illustrated in FIG. 3;

FIG. 5 is a diagram illustrating a display example of a chart display setting screen;

FIG. 6 is a diagram illustrating a data configuration example of a line resource master data;

FIG. 7 is a diagram illustrating a display example of a chart display setting screen;

FIG. 8 is a diagram illustrating a display example of a chart display setting screen;

FIG. 9 is a diagram illustrating a data configuration example of a process master data;

FIG. 10 is a diagram illustrating a display example of a chart display setting screen;

FIG. 11 is a diagram illustrating a display example of charts of line resources and a process;

FIG. 12 is a diagram illustrating a data configuration example of manufacturing plan information;

FIG. 13 is a diagram illustrating a data configuration example of a line manufacturing procedure master data;

FIG. 14 is a diagram illustrating a data configuration example of arranged plan information;

FIG. 15 is a diagram illustrating a display example of a chart of a process;

FIG. 16 is a diagram illustrating a display example when an unallocated plan subject button illustrated in FIG. 15 is made valid;

FIG. 17 is a diagram illustrating a data configuration example of a process order master data;

FIG. 18 is a diagram illustrating one example of a procedure of allocating date and time to an unallocated task from a manufacturing plan list screen;

FIG. 19 is a diagram illustrating a display example of a chart of a process after execution of the procedure illustrated in FIG. 18;

FIG. 20 is a diagram illustrating a display example of a total task graph;

FIG. 21 is a diagram illustrating a display example of a tooltip;

FIG. 22 is a diagram illustrating a display example of a menu area;

FIG. 23 is a diagram illustrating a display example of a tooltip;

FIG. 24 is a diagram illustrating a display example when an unallocated plan subject button is made valid as another display example in a display area;

FIG. 25 is a diagram illustrating a display example when the unallocated plan subject button illustrated in FIG. 24 is made invalid;

FIG. 26 is a diagram illustrating a display example of a chart of a process when display in terms of day is carried out;

FIG. 27 is a diagram illustrating a display example of a chart of a process when an unallocated plan subject button illustrated in FIG. 26 is made valid;

FIG. 28 is a diagram illustrating a display example of a chart of a process when display in terms of week is carried out;

FIG. 29 is a diagram illustrating a display example of a chart of a process when an unallocated plan subject button illustrated in FIG. 28 is made valid;

FIG. 30 is a diagram illustrating a display example of a chart of a process when display in terms of month is carried out;

FIG. 31 is a diagram illustrating a display example of a chart of a process when an unallocated plan subject button illustrated in FIG. 30 is made valid; and

FIG. 32 is a flowchart illustrating an operation example of a server according to one embodiment.

### DESCRIPTION OF EMBODIMENT

Due to various causes such as increase in task information (for example, parts) and restrictions on the number of lines or workers, a task that does not fall within the specific period (that is not allocated) (hereinafter, often represented as “unallocated task”) is generated in some cases depending on the arrangement by the server.

If tasks have been already arranged, in order to estimate increase in the number of workers and overtime work about the unallocated task, the operator understands that a task spills out of a list of tasks or the like (unallocated task exists) and decides increase in the number of workers, the amount of overtime work, and so forth for arranging the unallocated task.

In the case of considering the unallocated task that is not arranged in a task plan (for example, is not displayed in a chart) and arranging the unallocated task in the task plan as above, the procedure increases and thus the task efficiency decreases in some cases.

An embodiment of the present disclosure will be described below with reference to the drawings. However, the embodiment to be described below is merely exemplification and does not intend to exclude application of various modifications and techniques that are not clearly specified in the following. For example, the present embodiment may be carried out with various modifications within such a range as not to depart from the gist thereof. In the drawings used in the following embodiment, a part given the same numeral represents the same or similar part unless particularly specified.

### [1] One Embodiment

### [1-1] Configuration Example of System

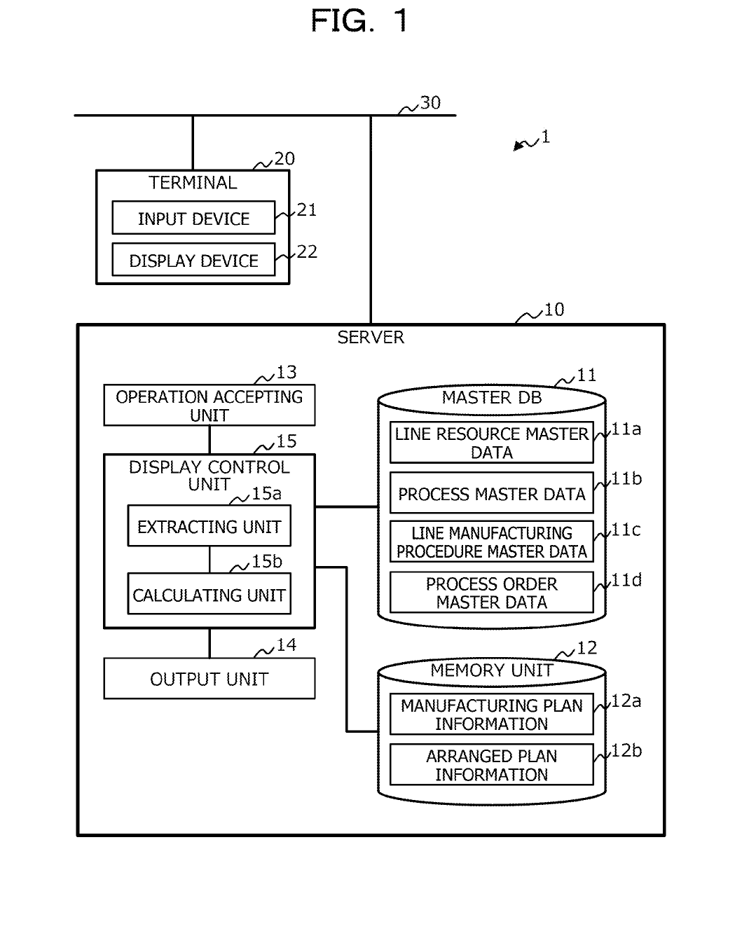

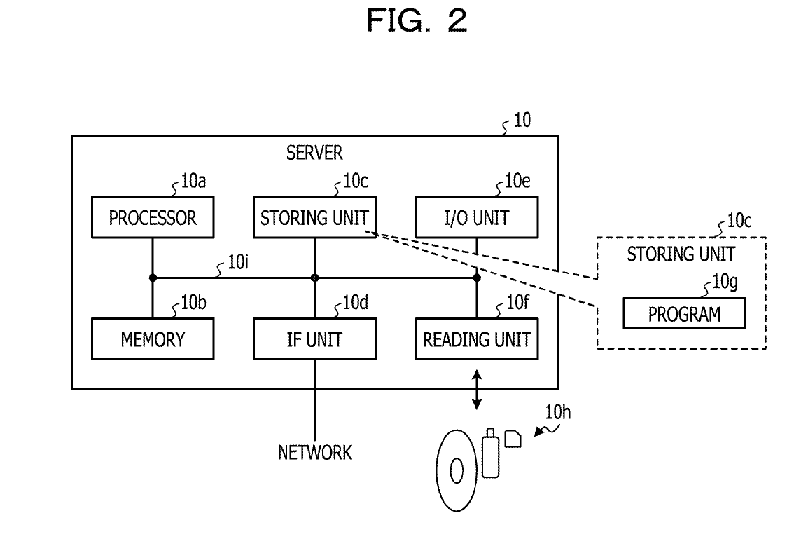

FIG. 1 is a block diagram illustrating a functional configuration example of a system 1 according to one embodiment and FIG. 2 is a block diagram illustrating a hardware configuration example of a server 10.

As illustrated in FIG. 1, the system 1 may illustratively include the server 10 and a terminal 20. Plural terminals 20 may exist in the system 1.

The server 10 is one example of task plan creation apparatus. The server 10 may cause the terminal 20 to display a task plan by executing processing relating to creation of the task plan according to access from the terminal 20 and sending the processing result to the terminal 20 as a response.

The terminal 20 is one example of terminal apparatus and may be positioned as a client for the server 10. As illustrated in FIG. 1, the terminal 20 may illustratively include an input device 21 and a display device 22. The terminal 20 may access the server 10 through operation of the input device 21 by an operator and display the response (processing result) from the server 10 on the display device 22.

Communication between the terminal 20 and the server 10 may be inter-application communication between a client application on the side of the terminal 20 and a server application on the side of the server 10. In this communication, communication between a Web browser on the side of the terminal 20 and a Web server on the side of the server 10 based on the Hypertext Transfer Protocol (HTTP) or the like may be included.

The server 10 and the terminal 20 may be coupled mutually communicably through a network 30 including one or both of wired and wireless networks. As the network 30, networks corresponding to standards such as Ethernet (registered trademark) and InfiniBand are cited, for example.

### Hardware Configuration Example

Next, the hardware configuration example of the server 10 will be described. The terminal 20 may have a hardware configuration similar to that of the server 10. In the following, the hardware configuration example of the server 10 will be described as a representative of the server 10 and the terminal 20.

As illustrated in FIG. 2, the server 10 as one example of a computer or information processing apparatus may illustratively include a processor 10a, a memory 10b, a storing unit 10c, an interface (IF) unit 10d, an input/output (I/O) unit 10e, and a reading unit 10f.

The processor 10a is one example of an arithmetic processing device that carries out various kinds of control and arithmetic operation. The processor 10a may be coupled to the respective blocks 10b to 10f mutually communicably by a bus 10i. As the processor 10a, integrated circuits (ICs) such as CPU, GPU, MPU, DSP, ASIC, and PLD (for example, FPGA) may be used. The CPU is an abbreviation for Central Processing Unit. The GPU is an abbreviation for Graphics Processing Unit. The MPU is an abbreviation for Micro Processing Unit. The DSP is an abbreviation for Digital Signal Processor. The ASIC is an abbreviation for Application Specific Integrated Circuit. The PLD is an abbreviation for Programmable Logic Device. The FPGA is an abbreviation for Field Programmable Gate Array.

The memory 10b is one example of hardware that stores various pieces of data and programs. As the memory 10b, a volatile memory, for example, a RAM such as a dynamic RAM (DRAM), is cited. The RAM is an abbreviation for Random Access Memory.

The storing unit 10c is one example of hardware that stores various pieces of data, programs, and so forth. For example, the storing unit 10c may be used as a secondary storing device of the server 10 and an operating system (OS), firmware, programs such as applications, and various kinds of data may be stored. As the storing unit 10c, magnetic disk devices such as a hard disk drive (HDD), semiconductor drive devices such as a solid state drive (SSD), and various kinds of storing devices such as a non-volatile memory are cited, for example. As the non-volatile memory, flash memory, storage class memory (SCM), read only memory (ROM), and so forth are cited, for example. The storing unit 10c may store a program 10g that implements all or part of various kinds of functions of the server 10.

The IF unit 10d is one example of a communication interface that carries out control and so forth of coupling and communication with the terminal 20 through the network 30. For example, as the IF unit 10d, an adapter compliant with Ethernet (registered trademark), InfiniBand, or the like is cited. The server 10 may include a communication interface that carries out control and so forth of coupling and communication with a management terminal of an administrator and may download the program 10g from a network that is not diagrammatically represented by using this communication interface.

The I/O unit 10e may include at least one of input devices such as mouse, keyboard, touch panel, and operation button and output devices such as display, projector, and printer, for example. For example, the input device 21 of the terminal 20 illustrated in FIG. 1 is one example of the input device of the I/O unit 10e and the display device 22 is one example of the output device of the I/O unit 10e.

The reading unit 10f is one example of a reader that reads out data and program recorded in a recording medium 10h and outputs the data and program to the processor 10a. The reading unit 10f may include a coupling terminal or device to or in which the recording medium 10h may be coupled or inserted. As the reading unit 10f, an adapter compliant with Universal Serial Bus (USB) or the like, a drive device that accesses a recording disc, a card reader that accesses a flash memory such as a standard definition (SD) card, and so forth are cited, for example. The program 10g and so forth may be stored in the recording medium 10h.

As the recording medium 10h, non-transitory computer-readable recording media such as magnetic/optical discs and flash memories are cited illustratively. As the magnetic/optical discs, flexible disc, Compact Disc (CD), Digital Versatile Disc (DVD), Blu-ray Disc, Holographic Versatile Disc (HVD), and so forth are cited illustratively. As the flash memories, semiconductor memories such as USB memory and SD card are cited illustratively. As the CD, CD-ROM, CD-recordable (CD-R), CD-rewritable (CD-RW), and so forth are cited illustratively. Furthermore, as the DVD, DVD-ROM, DVD-RAM, DVD-R, DVD-RW, DVD+R, DVD+RW, and so forth are cited illustratively.

The hardware configuration of the above-described server 10 is exemplification. Therefore, increase or decrease in the hardware (for example, addition or deletion of an arbitrary block), separation, integration based on an arbitrary combination, addition or omission of a bus, and so forth in the server 10 may be carried out as appropriate.

### Functional Configuration Example

Next, a functional configuration example of the server 10 will be described.

The server 10 creates a task plan by allocating date and time to task information with which a time limit is associated. As the task plan, a manufacturing plan of processing, assembly, and so forth of a product in a factory or the like is cited, for example. In the following description, a manufacturing plan is cited as an example as the task plan.

Here, as described above, there is the case in which, after arrangement of tasks, the operator grasps the existence of an unallocated task from a list of tasks or the like and considers increase in the number of workers, the amount of overtime work, and so forth for arranging the unallocated task.

In contrast, the server 10 according to the one embodiment enables visualizing the task time of the unallocated task that does not fall within a specific period, for example, displaying the task time as a load graph, in arrangement of tasks. Due to this, the unallocated task may be estimated in advance in the arrangement of tasks and thus the procedure for decision of the workers and the amount of overtime work by the operator may be reduced.

As illustrated in FIG. 1, the server 10 may illustratively include a master data database (DB) 11, a memory unit 12, an operation accepting unit 13, an output unit 14, and a display control unit 15.

The master data DB 11 is a database that stores and manages various kinds of master data information used for generation of the manufacturing plan. For example, the master data DB 11 may store and manage line resource master data 11a, process master data 11b, line manufacturing procedure master data 11c, and process order master data 11d.

The memory unit 12 stores various kinds of information used for generation of the manufacturing plan, for example, transaction information. For example, the memory unit 12 may store manufacturing plan information 12a and arranged plan information 12b.

The master data DB 11 and the memory unit 12 may be each implemented by a storage area of at least part of the memory 10b or the storing unit 10c of the server 10 illustrated in FIG. 2. Details of these pieces of information stored by the master data DB 11 and the memory unit 12 will be described later in explanation of a display control example by the display control unit 15.

The operation accepting unit 13 accepts an access request from the terminal 20 and outputs instructions according to the access request to the display control unit 15. As the access request, a request for operation on a screen relating to the manufacturing plan displayed on the display device 22 is cited, for example.

The output unit 14 transmits a processing result from the display control unit 15 to the terminal 20. As the processing result, screen information according to the request for operation to the screen relating to the manufacturing plan is cited, for example. As the screen information, various kinds of information such as information on chart, graph, and text, information relating to screen control of window, tooltip, and so forth, various kinds of parameters, and control information are cited, for example.

In the processing result, the creation result of a task plan by the display control unit 15, for example, information relation of the allocation result of each task, may be included. This information may be output to the terminal 20 or another system and be referenced in management, execution, and so forth of tasks in the output destination.

The display control unit 15 carries out display control of the screen displayed on the display device 22 according to instructions from the operation accepting unit 13 and outputs the processing result to the output unit 14. In the display control, generation and update of information on chart, graph, text, and so forth displayed on the screen, screen transition and screen control, control of the scale, and so forth may be included.

The display control unit 15 may illustratively include an extracting unit 15a and a calculating unit 15b.

When the total of the task time of task information to which date and time in a specific period is allocated is displayed, the extracting unit 15a extracts one or more piece of task information (unallocated task information) whose time limit corresponds to the specific period among pieces of task information to which no date and time is allocated (unallocated task information).

The calculating unit 15b calculates the total of the task time of the one or more piece of task information (unallocated task information) extracted by the extracting unit 15a.

The total of the task time of the unallocated task information calculated by the calculating unit 15b may be displayed on the display device 22 as a graph that represents this total in conjunction with a graph that represents the total of the task time of the task information to which date and time in the specific period is allocated, for example. Such control may be included in the display control by the display control unit 15.

Furthermore, the total of the task time of the unallocated task information may be controlled by the display control unit 15 in such a manner as to be displayed on the display device 22 together with the total of the task time of the task information to which date and time in the specific period is allocated.

### [1-2] Display Control Example by Display Control Unit

Next, one example of the display control by the display control unit 15 will be described by using a display example of the screen displayed on the display device 22 of the terminal 20.

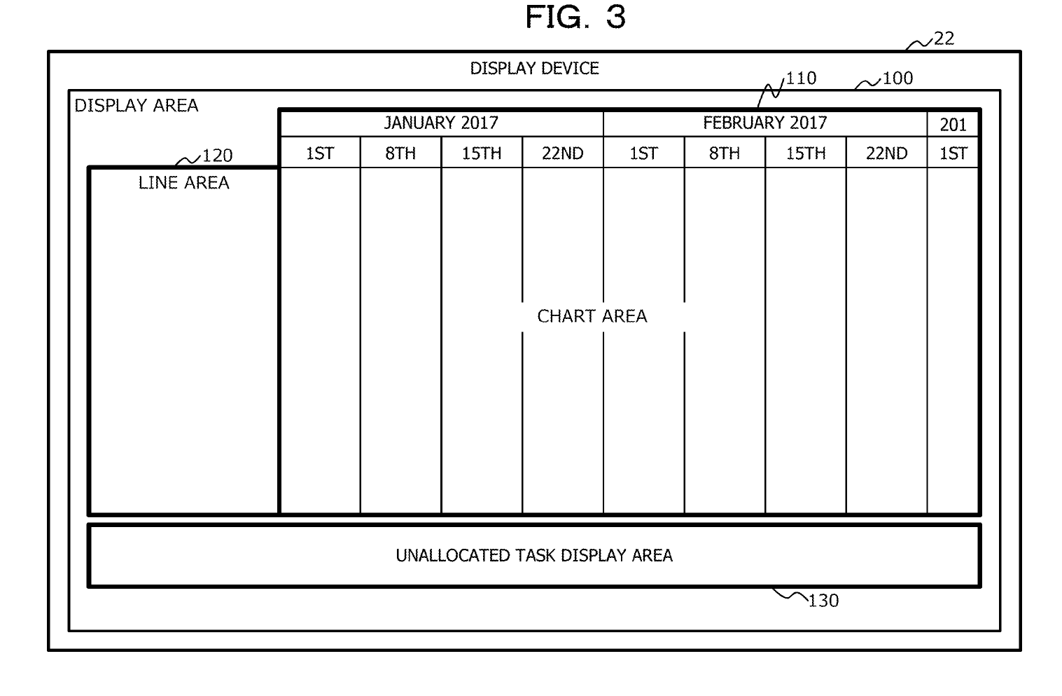

As exemplified in FIG. 3, on the screen of the display device 22, a chart area 110, a line area 120, and an unallocated task display area 130 may be displayed in a display area 100, for example, a window of an application or browser with which a task plan is created.

In the line area 120, elements such as processes and lines are displayed, for example. In the chart area 110, one kind or plural kinds of charts (multi-charts) may be displayed regarding the elements of the line area 120. In the unallocated task display area 130, information relating to the unallocated task (diagrammatic representation is omitted) is displayed. For example, an operator may allocate unallocated tasks to a specific period of the chart area 110 from the unallocated task display area 130 by drag and drop with a pointer such as a mouse pointer.

The display control unit 15 may carry out various kinds of display control to be described later according to a request for operation from the operator to the inside of the display area 100 through the input device 21. In the following description, it is assumed that transition and update of the screen, display of window and tooltip, calculation of various kinds of data, and so forth in the display area 100 are carried out by the display control unit 15.

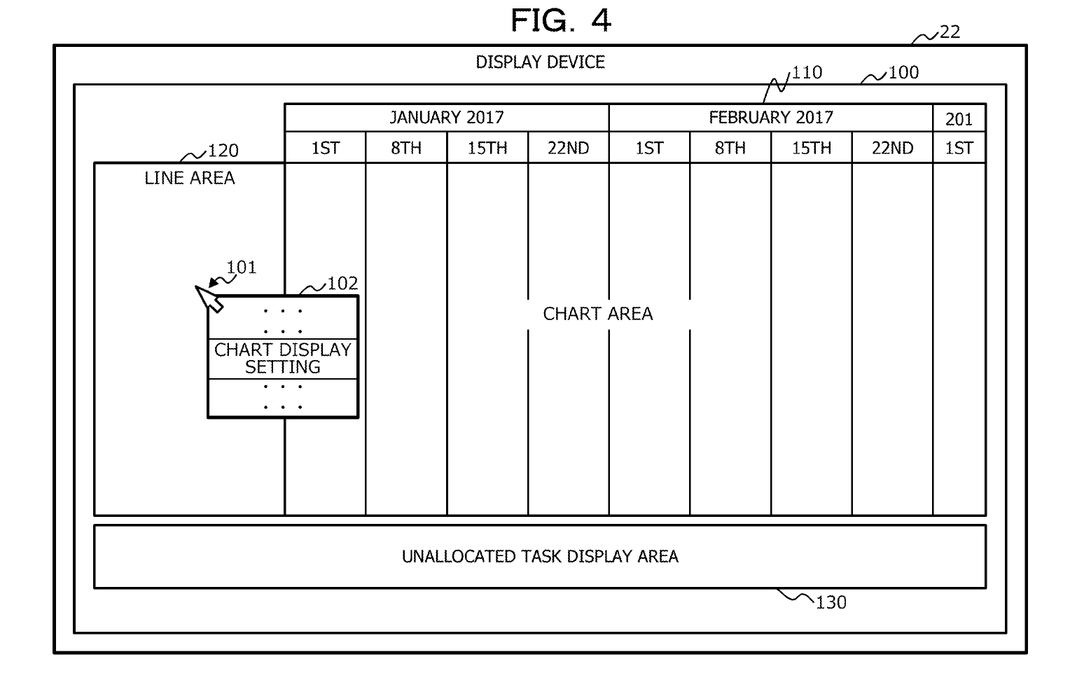

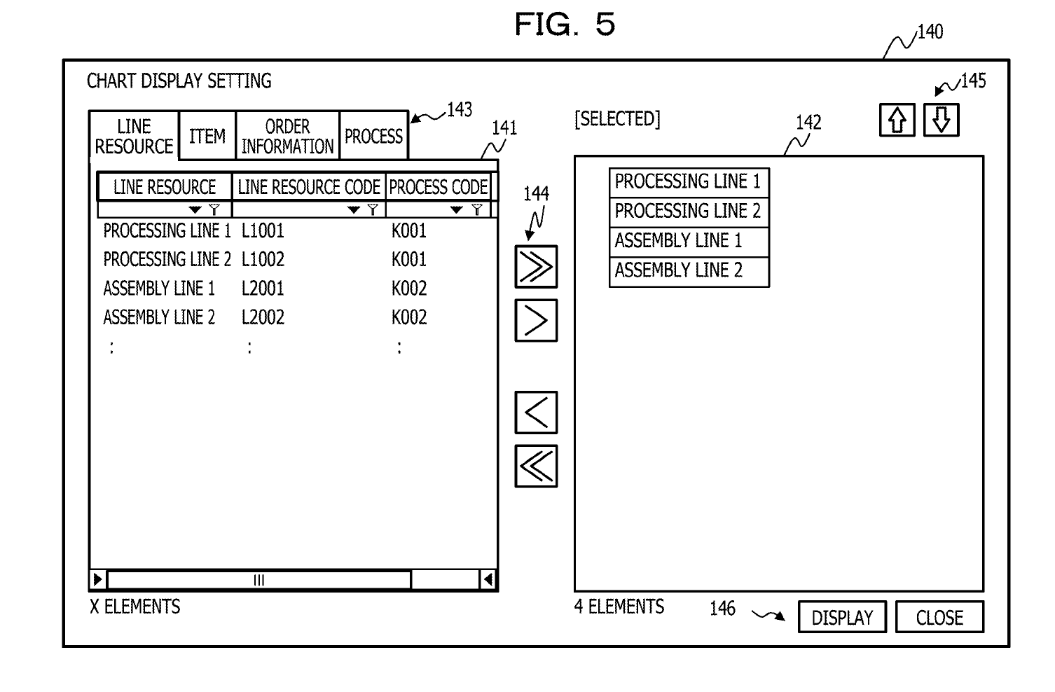

For example, as illustrated in FIG. 4, if a right click of a pointer 101 is operated on the line area 120 and “chart display setting” of a right-click menu 102 is selected, a chart display setting screen 140 illustrated in FIG. 5 may be displayed as a modal window, for example.

As exemplified in FIG. 5, a display candidate element list area 141 that may be switched by tabs 143 and a displayed element list area 142 may be included in the chart display setting screen 140.

The display candidate element list area 141 is an area in which elements of candidates for being displayed in the line area 120 are displayed as a list. Through selection of an element in the display candidate element list area 141 and pressing-down of “>” of element movement buttons 144, the element moves to the displayed element list area 142. “>>” of the element movement buttons 144 is a button to collectively move all elements in the display candidate element list area 141 in the selected tab 143 to the displayed element list area 142. “<” and “<<” are buttons to carry out selective movement and collective movement, respectively, from the displayed element list area 142 to the display candidate element list area 141.

The displayed element list area 142 is an area in which elements to be displayed in the line area 120 are displayed as a list. If elements have been already displayed in the line area 120, the elements displayed in the line area 120 may be initially displayed in the displayed element list area 142. In the example of FIG. 5, “processing line 1,” “processing line 2,” “assembly line 1,” and “assembly line 2” are displayed in the displayed element list area 142.

Up/down-buttons 145 are buttons to change the order of the elements of the displayed element list area 142. A display button 146 is a button to display the elements of the displayed element list area 142 in the line area 120. When this display button 146 or a “close” button is pressed down, the chart display setting screen 140 ends.

The tabs 143 may illustratively include “line resource,” “item,” “order information,” and “process.” The example of FIG. 5 represents the state in which the “line resource” is selected.

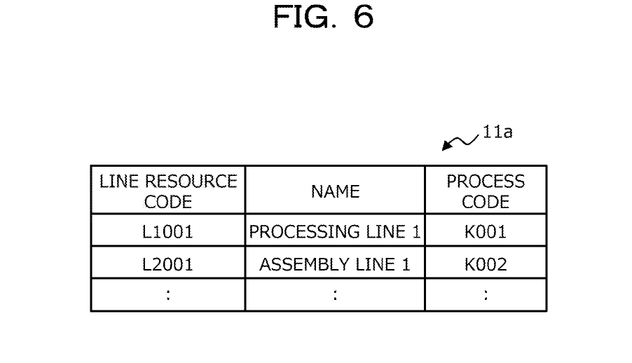

If the “line resource” is selected in the tabs 143, elements based on the line resource master data 11a exemplified in FIG. 6 may be displayed in the display candidate element list area 141.

The line resource master data 11a is information to manage line resources and may illustratively include information on “line resource code,” “name,” and “process code” as illustrated in FIG. 6.

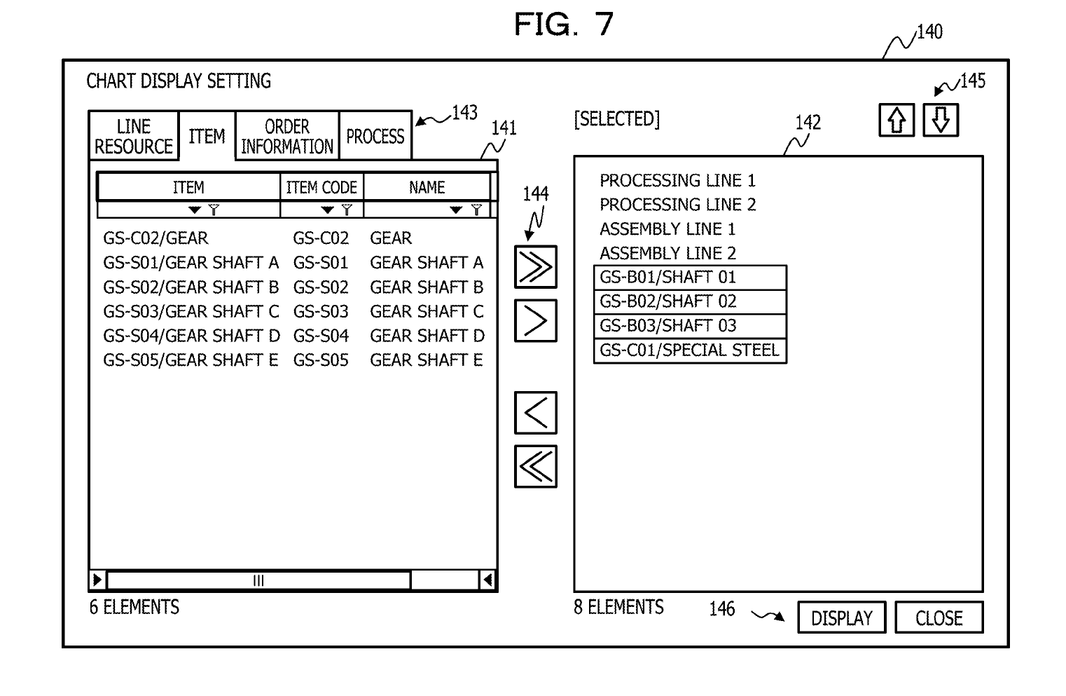

In FIG. 7, one example of the chart display setting screen 140 when the “item” is selected in the tabs 143 is illustrated. If the “item” is selected in the tabs 143, elements based on master data that relates to the “item” and is not diagrammatically represented may be displayed in the display candidate element list area 141.

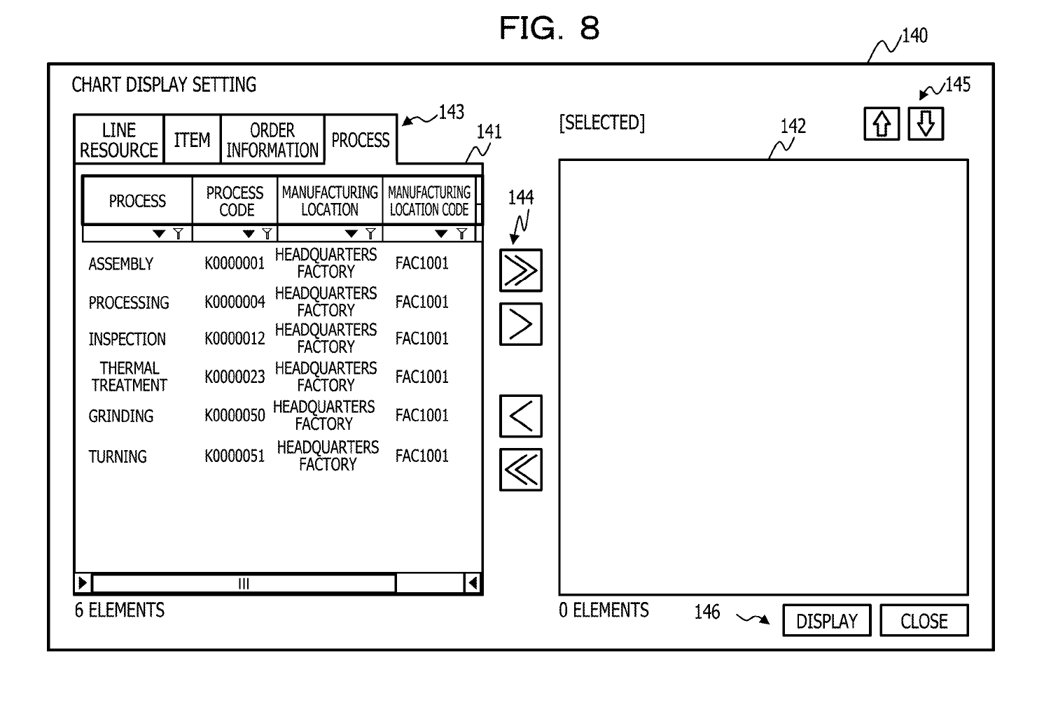

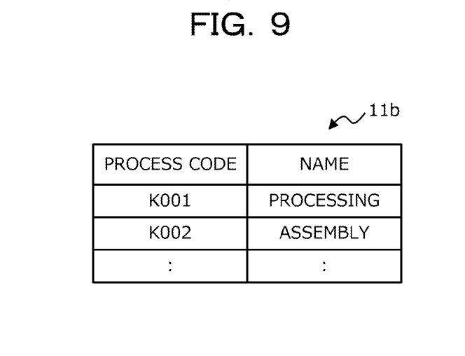

Furthermore, in FIG. 8, one example of the chart display setting screen 140 when the “process” is selected in the tabs 143 is illustrated. If the “process” is selected in the tabs 143, elements based on the process master data 11b exemplified in FIG. 9 may be displayed in the display candidate element list area 141.

The process master data 11b is information to manage the process and may illustratively include information on “process code” and “name” as illustrated in FIG. 9.

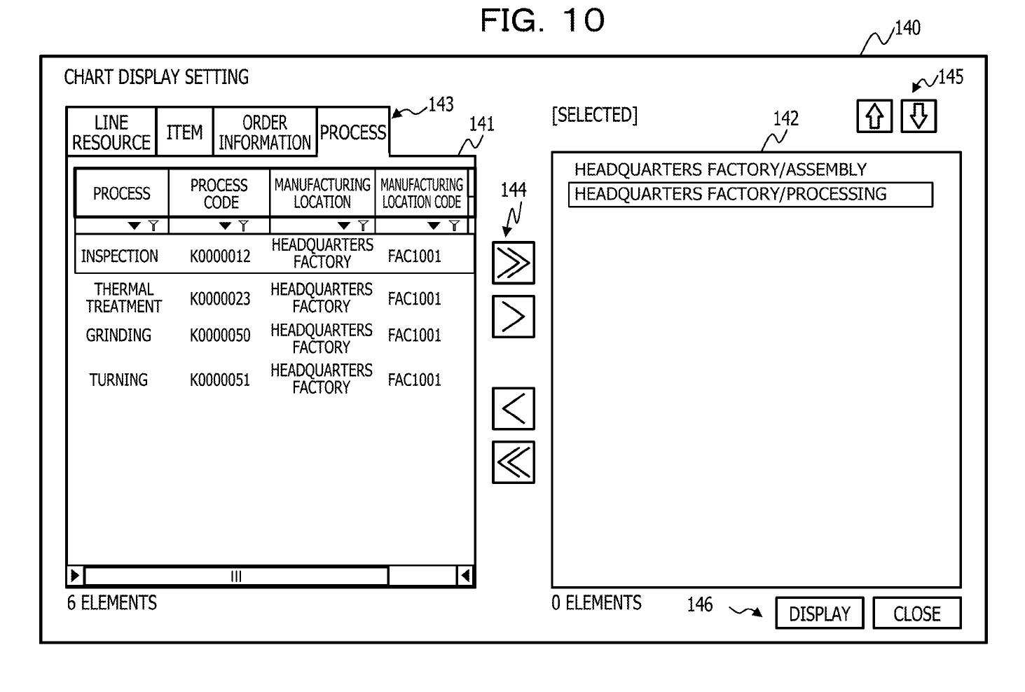

In FIG. 10, an example in which “headquarters factory/assembly” and “headquarters factory/processing” are displayed in the displayed element list area 142 in FIG. 8 is illustrated.

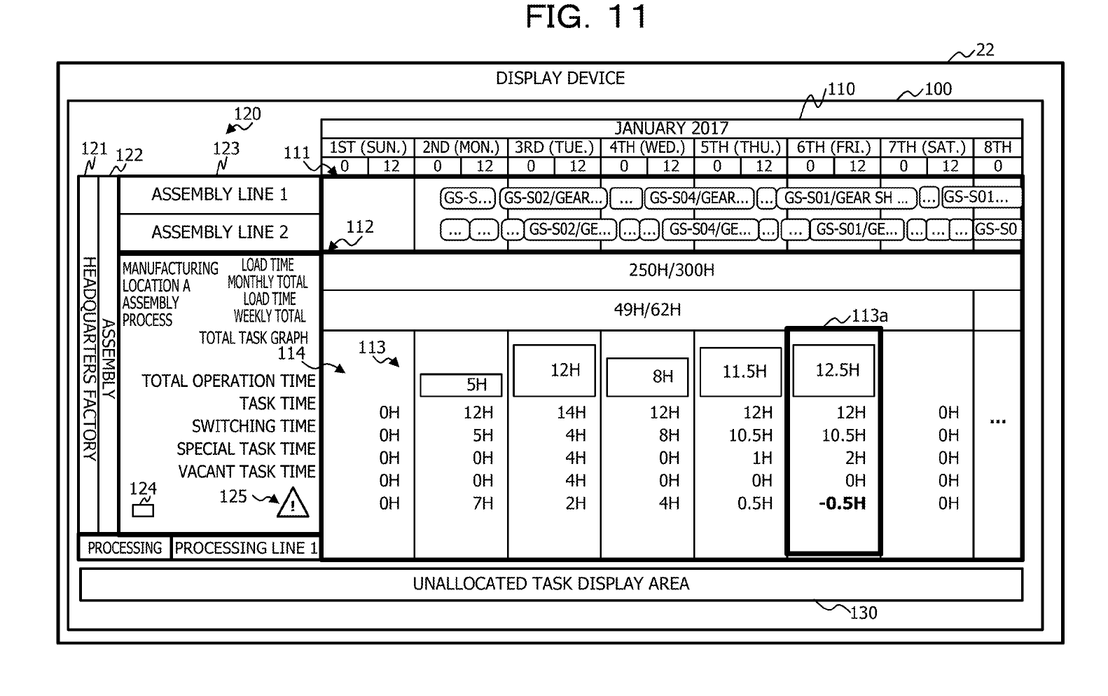

FIG. 11 is a diagram illustrating a display example of the display area 100 when charts of the “line resource” and the “process” represented in FIG. 5 and FIG. 10 are displayed.

As exemplified in FIG. 11, hierarchical element areas 121 to 123 may be displayed in the line area 120. Furthermore, in the chart area 110, a Gantt chart 111 of tasks relating to the “line resource” and a process load chart 112 of tasks relating to the “process” may be displayed.

In the element areas 121 to 123, elements of line resources, items, and so forth are hierarchically displayed. For example, in the case of the line, each “line” may be displayed in the element area 123 and the “process” may be displayed in the element area 122 and the “manufacturing location” may be displayed in the element area 121. A chart may be displayed regarding each element area 123 (for example, line) in the Gantt chart 111 and a chart may be displayed regarding each element area 122 (for example, process) in the process load chart 112.

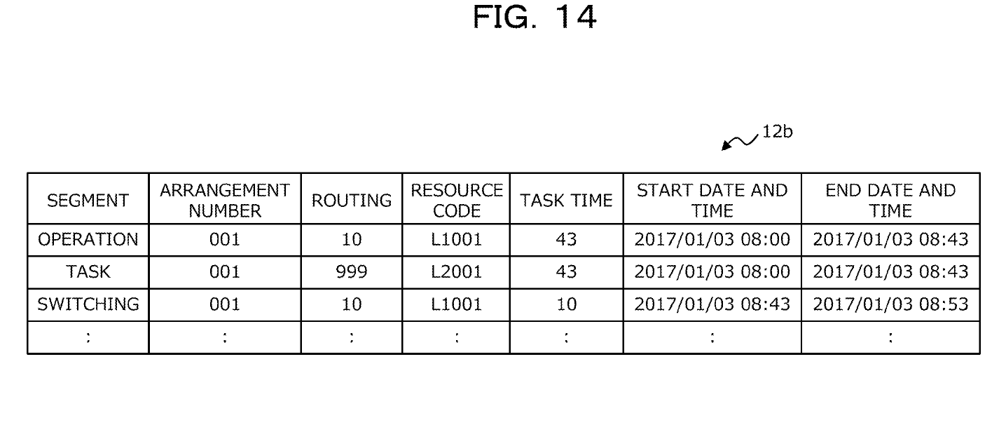

The Gantt chart 111 is a chart in which already-allocated tasks are lined up in a time-series manner. In the Gantt chart 111, tasks based on the arranged plan information 12b exemplified in FIG. 14 may be displayed.

The arranged plan information 12b is information to manage the arranged plan of already-allocated tasks and may illustratively include information on “segment,” “arrangement number,” “routing,” “resource code,” “task time,” “start date and time,” and “end date and time” as illustrated in FIG. 14. The “arrangement number” is information that represents the manufacturing order and may be referred to as “manufacturing order number.” The “resource code” is identification information of the line resource and may be referred to as “line resource code.”

The “start date and time” and “end date and time” represent the date and time of start and end allocated to the task, for example, the period during which a line is used due to the already-allocated task. The “end date and time” may be obtained by adding the “task time” to the date and time to which the task is allocated (equivalent to “start date and time”).

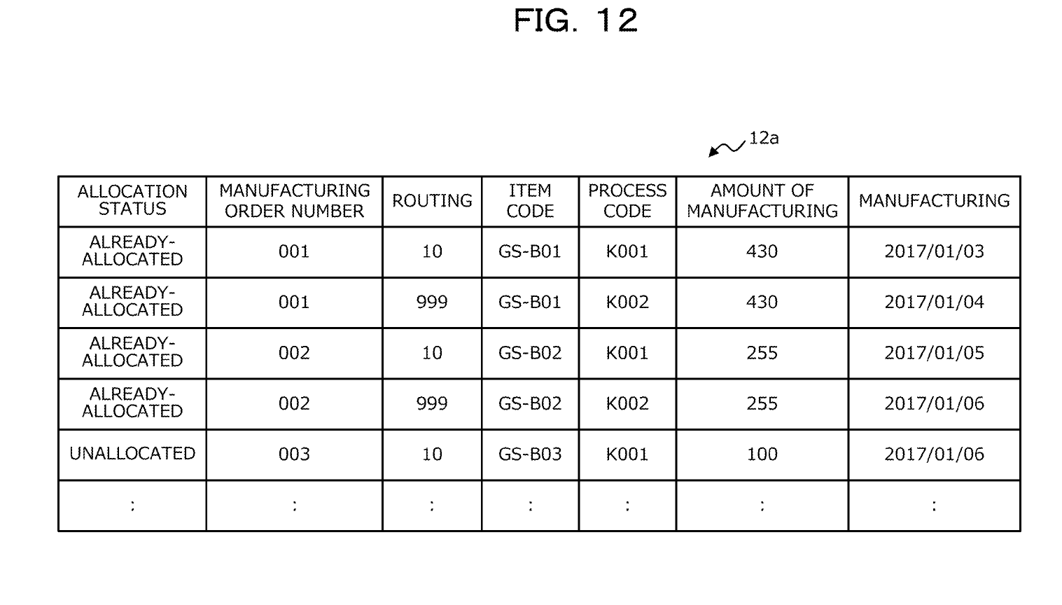

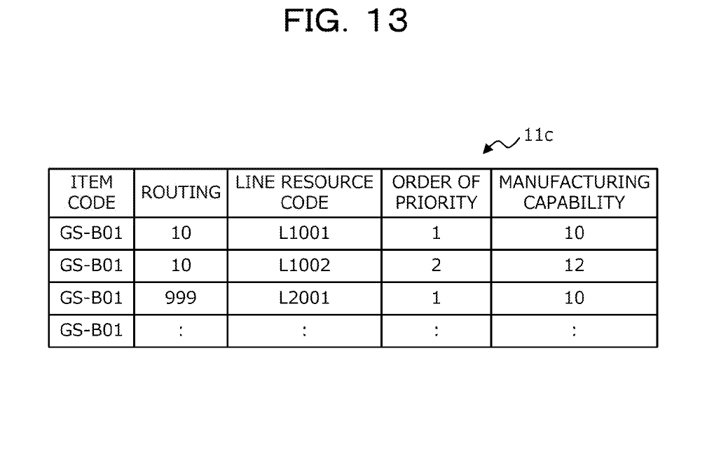

Here, the “task time” may be calculated based on the manufacturing plan information 12a illustrated in FIG. 12 and the line manufacturing procedure master data 11c illustrated in FIG. 13.

The manufacturing plan information 12a is information to manage the manufacturing plan of products or parts and entries may be added based on creation instructions (manufacturing orders) of products or parts from an operator or another system, for example. As illustrated in FIG. 12, the manufacturing plan information 12a may illustratively include “allocation status,” “manufacturing order number,” “routing,” “item code,” “process code,” “amount of manufacturing,” and “manufacturing deadline” as one example of the time limit. The “routing” is information that represents the order of the task and indicates that the task is carried out earlier when the value of the “routing” is smaller, for example.

In the one embodiment, the “task information” may represent information on one entry in the manufacturing plan information 12a, for example. “Allocating date and time to task information” may include a series of processing (or at least part of this processing) of allocating the date and time of use of a line to a task represented in a certain entry and setting the “allocation status” of this entry to “already-allocated” in the manufacturing plan information 12a. The “task information” may be referred to simply as “task.”

The line manufacturing procedure master data 11c is information to manage the manufacturing procedure in the line regarding each item and may illustratively include “item code,” “routing,” “line resource code,” “order of priority,” and “manufacturing capability” as illustrated in FIG. 13. The “order of priority” represents the degree of priority of use of the line resource in the case in which a task of the same item and the same routing may be carried out by any of plural line resources. The “manufacturing capability” represents the number of parts that may be manufactured in one minute in the line resource, for example.

For example, regarding the task of the part as the target, the display control unit 15 may calculate the “task time” by dividing the corresponding “amount of manufacturing” of the manufacturing plan information 12a by the corresponding “manufacturing capability” of the line manufacturing procedure master data 11c.

For example, the task information to which date and time has been already allocated is associated with a line regarding which the manufacturing capability is set, and the task time of this already-allocated task information is the task time calculated according to the manufacturing capability of the line associated with the task to which date and time in a specific period is allocated. This allows estimation of the accurate task time.

Referring back to FIG. 11, the process load chart 112 is a chart in which the load (for example, task time) of the process in each specific period is visualized.

For example, in the process load chart 112, a monthly total area, a weekly total area, a total task graph 113, and a breakdown area 114 of the load may be displayed.

The total task graph 113 is one example of a first area. In the total task graph 113, a graph (for example, bar graph) that represents the total task time may be displayed. In the total task graph 113, the total task time may be displayed in association with (in combination with) the total task graph 113. Although the total task graph 113 is displayed in terms of time in the example of FIG. 11, the total task graph 113 may be displayed in terms of the amount of manufacturing instead of the time display in the process load chart 112. The amount-of-manufacturing display will be described later.

Here, the total task time may be obtained based on the total of task time, switching time, special task time, and stop time, for example. The task time is the time during which a task such as assembly or processing by use of lines is carried out, and the switching time is the time during which switching between tasks, such as cleaning of the lines and replacing of a jig, is carried out. Furthermore, the special task time is the time during which tasks outside master data management, such as tasks relating to a prototype and maintenance, are carried out, and the stop time is the time during which the lines are stopped, such as periodic inspection and holiday.

In the breakdown area 114, for example, the total of the total operation time, the total of the task time, the total of the switching time, the total of the special task time, and the total of the vacant time may be displayed regarding each day as illustrated in FIG. 11. The total operation time is the operation time of the lines obtained by adding the vacant task time to the total task time. The vacant task time is the time during which a task is not carried out in the lines, and is obtained by subtracting the total task time from the total operation time. The vacant task time may be displayed in a highlighted manner by red characters or the like when becoming a negative value.

The graph and the total task time of the total task graph 113 and the total operation time and the vacant task time of the breakdown area 114 may be the subject of display by default. On the other hand, the task time, the switching time, the special task time, the stop time, and the task time (unit is converted) of the breakdown area 114 may be non-displayed by default. The task time (unit is converted) is the task time whose unit of display has been converted for calculation of the number of personnel and so forth.

Here, in the example of FIG. 11, the total task graph 113 and the breakdown area 114 of “6 (Fri.)” are displayed in a highlighted manner as represented by numeral 113a. This is one example of warning display indicating that the total task time surpasses the total operation time (goes over the upper limit). In addition to or instead of the highlighting of numeral 113a, warning represented by numeral 125 may be displayed in the line area 120 of the relevant process load chart 112.

In the process load chart 112, an unallocated plan subject button 124 may be set in the line area 120. The unallocated plan subject button 124 is a button to carry out switching between the valid state and the invalid state of reflection of the unallocated task in the process load chart 112. An example in which the unallocated task is reflected in the process load chart 112 will be described later.

In the monthly total area and the weekly total area, the monthly total and the weekly total, respectively, of the total task time and the total operation time may be displayed in the case of time display. In the example of FIG. 11, in the monthly total area or the weekly total area, the monthly total or the weekly total of the total task time is represented on the left side of “/” (numerator) and the monthly total or the weekly total of the total operation time is represented on the right side of “/” (denominator). In the monthly total area and the weekly total area, highlighting may be carried out by red characters or the like if the numerical value on the left side of “I” surpasses the numerical value on the right side.

Arrangement of already-allocated tasks into the process load chart 112 like that exemplified in FIG. 11 may be implemented by known various methods. For example, the display control unit 15 may create and update the arranged plan information 12b by allocating the date and time of use of a line to tasks based on the task time based on the “amount of manufacturing” and the “manufacturing capability” and information on the “manufacturing order number” and so forth.

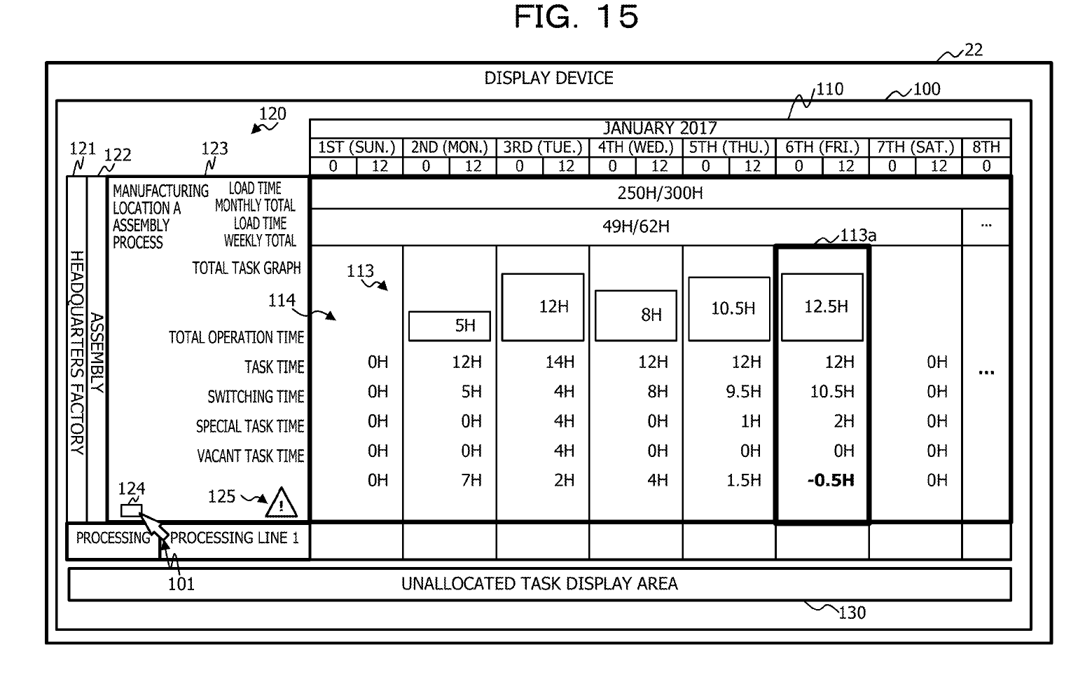

FIG. 15 is a diagram illustrating a display example of the display area 100 when the chart of the “process” represented in FIG. 10 is displayed. In the following, the case in which the unallocated plan subject button 124 is made valid will be described.

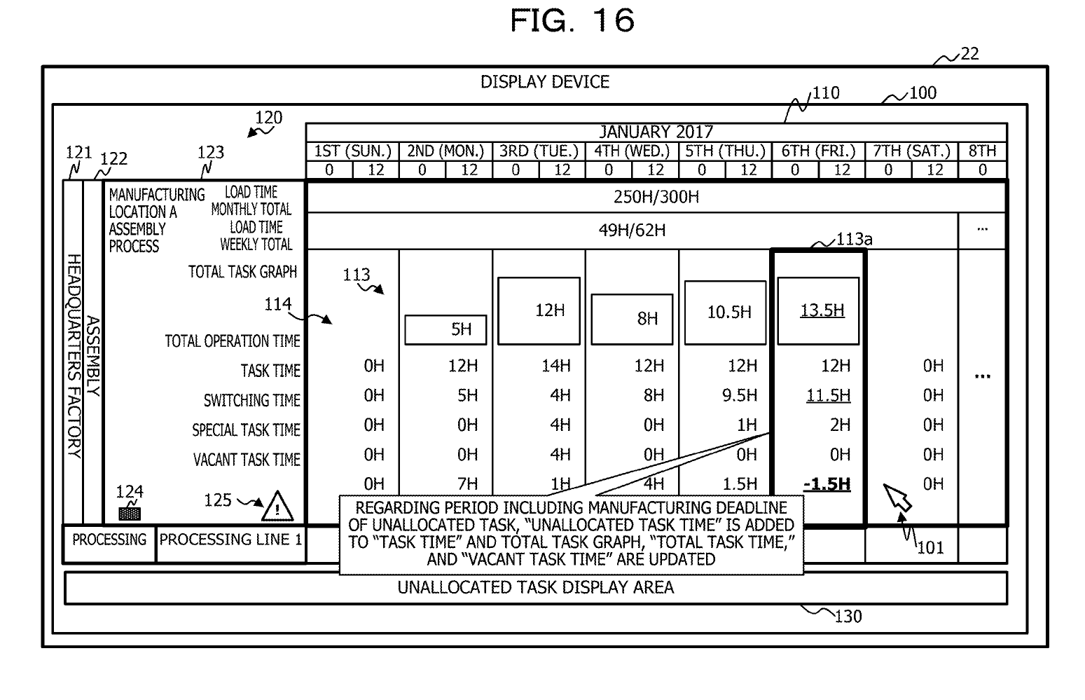

If the unallocated plan subject button 124 is made valid in FIG. 15 (for example, if a left click is made with the pointer 101), the process load including the plan of the unallocated task is displayed in the process load chart 112 as exemplified in FIG. 16. In FIG. 16, in the weekly total area, the total task graph 113, and the breakdown area 114, numerical values changed from FIG. 15 due to the validating of the unallocated plan subject button 124 are underlined. Furthermore, that the unallocated plan subject button 124 is valid is represented by hatching in FIG. 16.

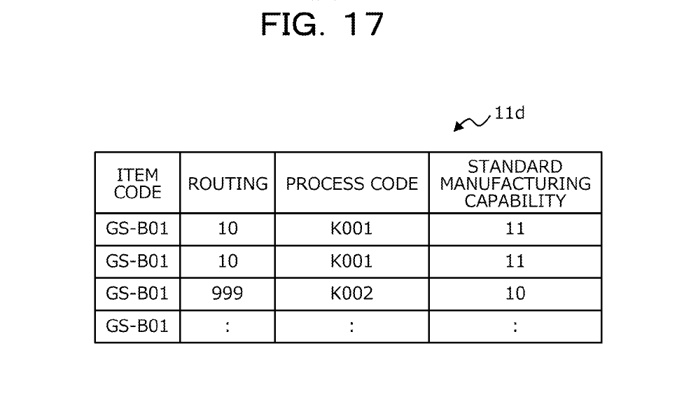

If the unallocated plan subject button 124 is made valid, the display control unit 15 may carry out display control of the process load chart 112 based on the manufacturing plan information 12a illustrated in FIG. 12 and the process order master data 11d illustrated in FIG. 17.

The process order master data 11d is information to manage the process order of tasks and may illustratively include “item code,” “routing,” “process code,” and “standard manufacturing capability” as illustrated in FIG. 17. The “standard manufacturing capability” is information that represents the standard manufacturing capability of the line used in a certain process. For example, in the “standard manufacturing capability,” the average value, the minimum value, or the like of the manufacturing capability of one or more lines corresponding to the relevant process in the line manufacturing procedure master data 11c illustrated in FIG. 13 may be set.

For example, if the manufacturing capability is different from line to line as in “L1001” and “L1002” of the “line resource code” in the line manufacturing procedure master data 11c, the task time relating to an unallocated task changes depending on which line the unallocated task is allocated to. Furthermore, recalculation of the task time occurs if an unallocated task allocated to a certain line is allocated (changed) to another line.

Therefore, in the one embodiment, the process order master data 11d including the “standard manufacturing capability,” which is an index of the standard manufacturing capability of the line, is used for calculation of the task time relating to the unallocated task (hereinafter, referred to as “unallocated task time”). It may be said that the unallocated task time calculated in this manner is a “standard task time” associated with the relevant unallocated task. By calculating the unallocated task time based on the “standard manufacturing capability” as above, the calculation may be made easy and the load of the server 10 may be reduced.

For example, regarding each specific period in the process load chart 112 (for example, “day,” which is the minimum display scale in FIG. 16), the extracting unit 15a of the display control unit 15 refers to the manufacturing plan information 12a and extracts the “unallocated” task whose “manufacturing deadline” is included in the relevant specific period.

Then, the calculating unit 15b of the display control unit 15 calculates the unallocated task time based on the “amount of manufacturing” in the manufacturing plan information 12a of the unallocated task extracted by the extracting unit 15a and the “standard manufacturing capability” regarding which the “item code” and the “process code” in the process order master data 11d are identical. For example, the calculating unit 15b may calculate the unallocated task time based on “amount of manufacturing”÷ “standard manufacturing capability.”

For example, it may be said that, regarding task information to which no date and time is allocated, the calculating unit 15b calculates the total of the task time of the task information to which no date and time is allocated regarding each date of the time limit associated with the task information.

The display control unit 15 updates the process load chart 112 based on the unallocated task time calculated by the calculating unit 15b. For example, the display control unit 15 may add the unallocated task time to the total task time of the total task graph 113 and the task time of the breakdown area 114 regarding the corresponding period. Furthermore, the display control unit 15 may subtract the unallocated task time from the vacant task time of the breakdown area 114. In association with the update of these pieces of information, the display control unit 15 may update the total task time of the monthly total area and the weekly total area.

If the unallocated plan subject button 124 is made valid regarding plural manufacturing locations or processes, the display control unit 15 may reflect the load of the unallocated task in the process load chart 112 of all of these manufacturing locations or processes. A “manufacturing location code,” which is not diagrammatically represented, may be included in the manufacturing plan information 12a. If a manufacturing location code is set in the “manufacturing location code” of an unallocated task, the display control unit 15 may display the load of the unallocated task regarding the manufacturing location corresponding to this manufacturing location code.

Incidentally, when the unallocated plan subject button 124 is made valid, the unallocated task is in the state of being provisionally allocated to the date and time of the manufacturing deadline and date and time is not actually allocated to the task. The operator may allocate date and time to the unallocated task by the following procedure based on the process load chart 112 in which the unallocated task is reflected.

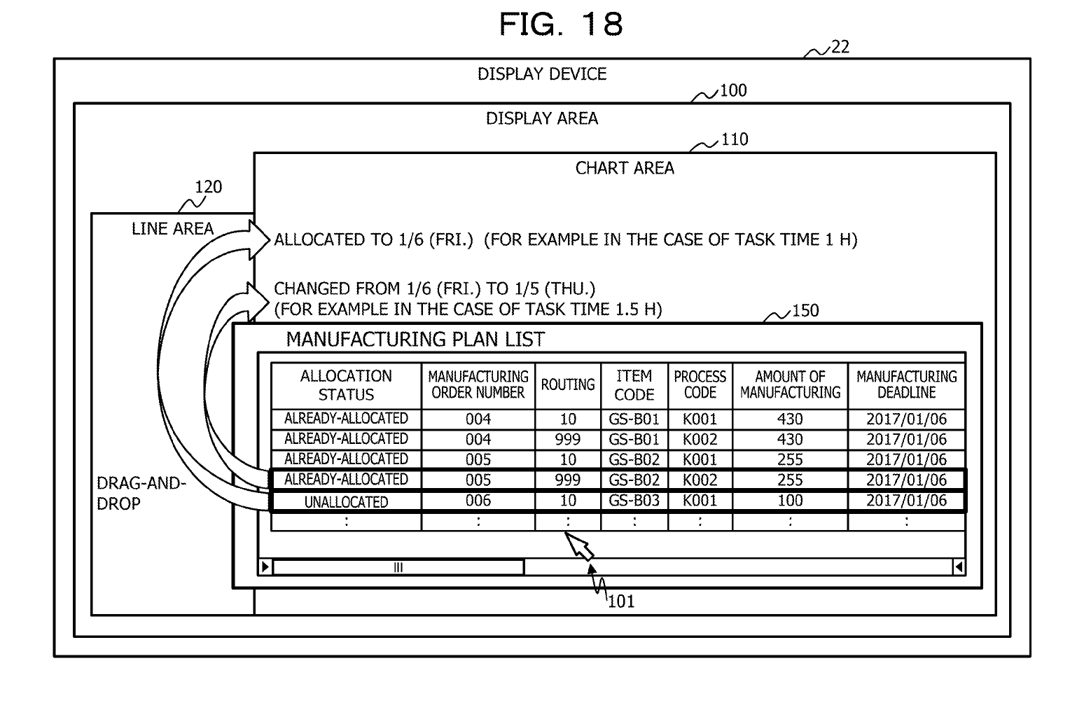

For example, if given operation (for example, double-click) is carried out on the screen of the process load chart 112 by the pointer 101 as illustrated in FIG. 16, a manufacturing plan list screen 150 illustrated in FIG. 18 may be displayed.

As exemplified in FIG. 18, in the manufacturing plan list screen 150, information that corresponds to the manufacturing plan information 12a illustrated in FIG. 12 and relates to both already-allocated and unallocated tasks may be displayed. For example, the operator may allocate date and time to an unallocated task by carrying out drag-and-drop of an entry displayed in the manufacturing plan list screen 150 into the process load chart 112 in the chart area 110 by the pointer 101. At this time, the operator may carry out drag-and-drop of also already-allocated tasks into another time zone (for example, date and time) of the process load chart 112 to optimize the manufacturing plan.

As one example, as illustrated in FIG. 18, the operator may carry out drag-and-drop of the “already-allocated” task with the “manufacturing order number” of “005” and the “routing” of “999” (for example, already allocated to “1/6 (Fri.),” task time 1.5 H) into the region of “1/5 (Thu.)” in the process load chart 112. Furthermore, the operator may carry out drag-and-drop of the “unallocated” task with the “manufacturing order number” of “006” and the “routing” of “10” (task time 1 H) into the region of “1/6 (Fri.)” in the process load chart 112.

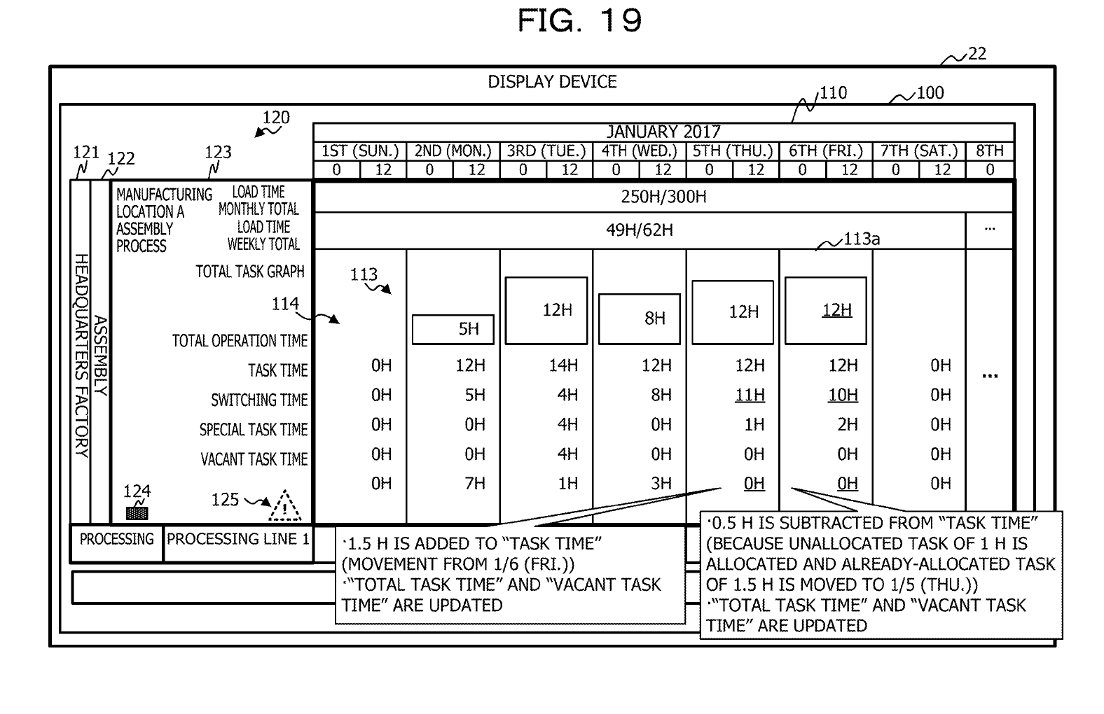

When detecting the drag-and-drop of the tasks from the manufacturing plan list screen 150 into the process load chart 112, the display control unit 15 may update information such as the “allocation status” of the manufacturing plan information 12a and the “start date and time” and the “end date and time” of the arranged plan information 12b. Furthermore, the display control unit 15 may update the process load chart 112 to a state illustrated in FIG. 19, for example.

As exemplified in FIG. 19, in the process load chart 112, information of the total task graph 113 and the breakdown area 114 of “1/5 (Thu.)” and “1/6 (Fri.)” is updated in accordance with the movement of the tasks by the drag-and-drop. Furthermore, the monthly total area and the weekly total area may also be updated. Moreover, as illustrated in FIG. 19, the period in which the upper limit is exceeded becomes absent and thus the warning display 113a and the display of 125 disappear.

In the state illustrated in FIG. 19, the unallocated task has been already allocated to date and time (1/6 (Fri.)). Thus, the display of the process load chart 112 does not change even when the unallocated plan subject button 124 is made invalid.

In this manner, with focus on the deadline of the unallocated task, the load of the unallocated task may be displayed in the process load chart 112. Thus, date and time on which the load concentrates may be presented to the operator. For example, the task time of the unallocated task may be visualized.

This allows the operator to carry out allocation of manufacturing plans (arrangement of tasks) in consideration of the actual load. Furthermore, even in the case in which excess over the upper limit is inevitable although already-allocated or unallocated tasks are moved by drag-and-drop as illustrated in FIG. 18, the operator may effectively plan the number of workers and the amount of overtime work in consideration of the actual load.

In the example of FIG. 18, the processing of allocating date and time to the unallocated task (and already-allocated task) by drag-and-drop by the operator may be executed by the display control unit 15 based on the “manufacturing deadline” of the manufacturing plan information 12a as a function of “automatic arrangement” of the unallocated task.

As above, the display control unit 15 is one example of a control unit that carries out control to allocate date and time to one or more pieces of unallocated task information based on the standard task time and time limits associated with the one or more pieces of the unallocated task information.

Furthermore, in the manufacturing plan list screen 150 illustrated in FIG. 18, information narrowed down based on the time zone by a filter may be displayed according to a time zone (for example, specific period of date and time or the like) on the process load chart 112 double-clicked by the pointer 101. The filter or a region in which a search is made may be set in the manufacturing plan list screen 150.

For example, in the case of an already-allocated task (already-arranged manufacturing plan), information on this task may be displayed in the manufacturing plan list screen 150 if either of the start date and time and the end date and time of the task is included in the range from the start date to the end date of the double-clicked time zone.

Furthermore, in the case of an unallocated task (unallocated manufacturing plan), information on this unallocated task may be displayed in the manufacturing plan list screen 150 if the manufacturing deadline of the task is included in the range from the start date to the end date of the double-clicked time zone.

If a double click of the pointer 101 is carried out on the process load chart 112 in the state in which the manufacturing plan list screen 150 is displayed, the manufacturing plan list screen 150 may be refreshed without carrying out additional screen display.

### [1-3] Display Example of Total Task Graph

Next, a display example of the total task graph 113 will be described.

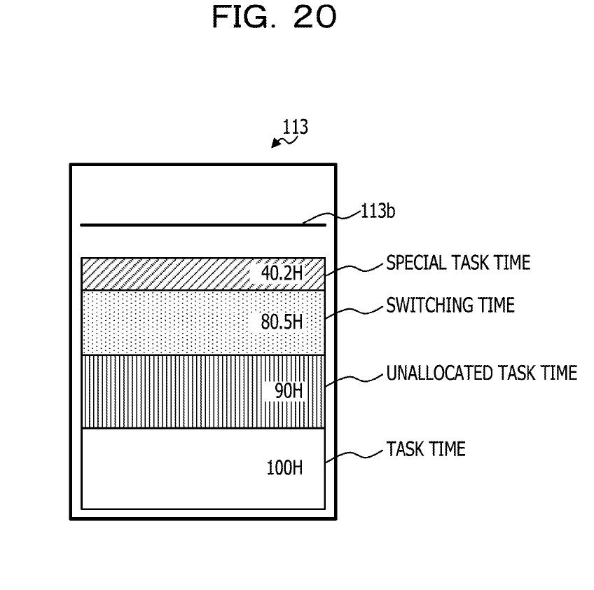

As illustrated in FIG. 20, illustratively the total task graph 113 displayed in the process load chart 112 may be displayed as a stacked graph according to the breakdown. In each breakdown graph in the total task graph 113, the time of the graph may be described in combination. The height of the whole of the total task graph 113 (load of the line) may be decided based on the ratio of total task time/total operation time.

Furthermore, in the total task graph 113, e.g. the total operation time may be represented as an upper-limit line 113b. The upper-limit line 113b (for example, 24 H in the case of the daily total, 148 H in the case of the weekly total, 840 H in the case of the monthly total) and the display upper limit of the total task graph 113 (for example, 120% of the upper-limit line 113b) may be defined by an option file.

As above, the display control unit 15 is one example of a display unit that displays a graph representing the total of the task time of one or more pieces of unallocated task information calculated by the calculating unit 15b in conjunction with a graph representing the total of the task time of task information to which date and time is allocated in a specific period. For example, it may be said that the display control unit 15 displays, in the total task graph 113, a graph including the part that represents the total of the task time of task information, the part that represents the total of the switching time between tasks, and the part that represents the total of the task time of unallocated task information in such a manner that these parts may be discriminated regarding each day.

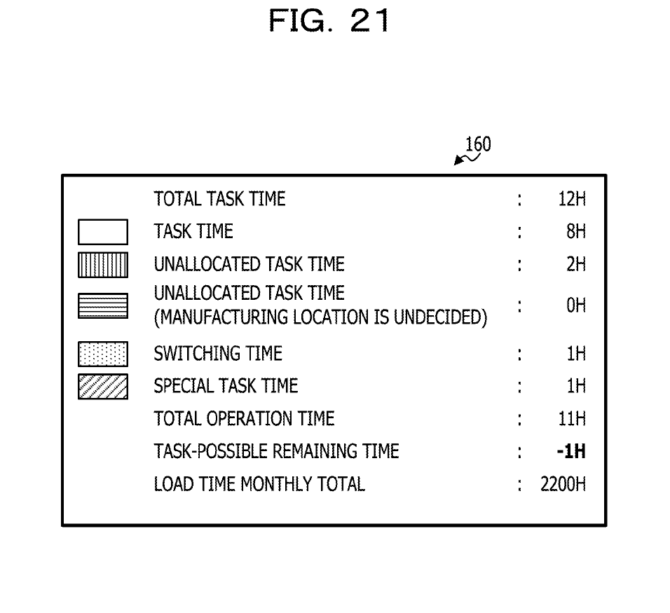

In the process load chart 112, a tooltip 160 exemplified in FIG. 21 may be displayed when the pointer 101 is put on the total task graph 113.

As exemplified in FIG. 21, legends and breakdown of the total task graph 113 may be displayed in the tooltip 160. For example, as the breakdown displayed in the tooltip 160, total task time, task time, unallocated task time, unallocated task time (manufacturing location is undecided), switching time, special task time, total operation time, task-possible remaining time (vacant task time), and load time monthly total may be included. These times may be described in combination in the breakdown.

### [1-4] Display Switching Example of Chart Area

Next, a switching example of display in the chart area 110 will be described.

(Display Switching Example of Process Load Chart)

In the above-described process load chart 112, an example in which the load is displayed in terms of time is illustrated. However, the load may be displayed in terms of the amount of manufacturing.

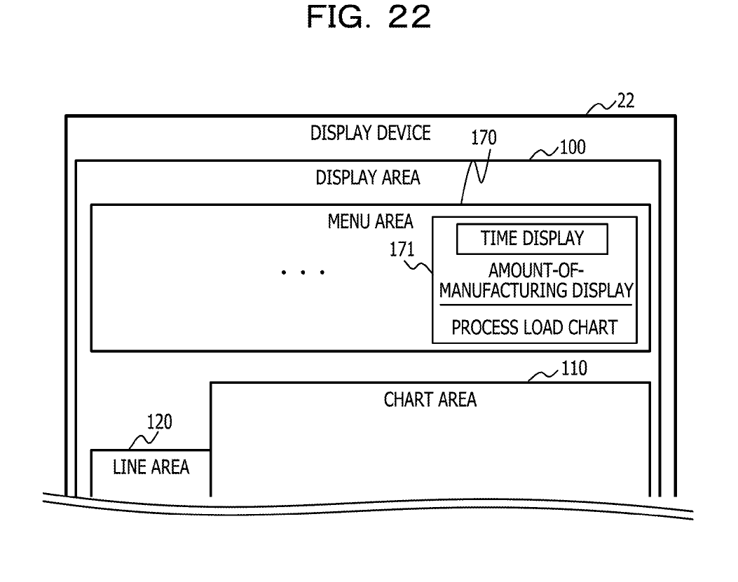

For example, in the display area 100, a menu area 170 (see FIG. 22) to carry out display switching of the process load chart 112 may be displayed on the upper side of the chart area 110 and the line area 120. The menu area 170 may be a form of a ribbon, toolbar, or the like.

As exemplified in FIG. 22, a switching area 171 to carry out display switching of the process load chart 112 may be displayed in the menu area 170. In the switching area 171, buttons of “time display” and “amount-of-manufacturing display” have a relationship of being exclusive to each other may be displayed.

The operator may switch the display of the process load chart 112 by clicking the button of either of “time display” and “amount-of-manufacturing display” by the pointer 101. For example, the display control unit 15 may carry out display switching to the selected display format in accordance with a definition for time display and a definition for amount-of-manufacturing display defined in an option file.

If the amount-of-manufacturing display is carried out in the process load chart 112, the total amount of manufacturing may be displayed in the total task graph 113 (see FIG. 15, FIG. 20, and so forth). The upper-limit line 113b in the total task graph 113 may be a line of the upper-limit amount of manufacturing.

Furthermore, in the monthly total area and the weekly total area, the monthly total and the weekly total, respectively, of the amount of manufacturing and the upper-limit amount of manufacturing may be displayed.

Moreover, in the breakdown area 114 (see FIG. 15 and so forth), instead of the total task time, the total operation time, the task time, the task time (unit is converted), and the vacant task time, the total amount of manufacturing, the upper-limit amount of manufacturing, the amount of manufacturing, the amount of manufacturing (unit is converted), and the vacant amount of manufacturing, respectively, may be displayed. The vacant amount of manufacturing is obtained by subtracting the total amount of manufacturing from the upper-limit amount of manufacturing. The amount of manufacturing (unit is converted) is the amount of manufacturing whose unit of display has been converted for calculation of the numbers of pallets and trucks and so forth. The upper-limit amount of manufacturing is the amount of manufacturing as the upper limit of manufacturing in the line and may be defined in the process master data 11b, for example.

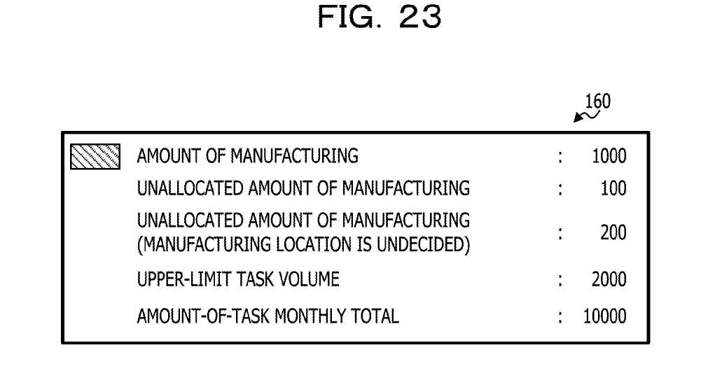

Furthermore, if the amount-of-manufacturing display is carried out in the process load chart 112, information exemplified in FIG. 23 may be included as the breakdown displayed in the tooltip 160 of the total task graph 113. For example, as the breakdown, the amount of manufacturing, the unallocated amount of manufacturing, the unallocated amount of manufacturing (manufacturing location is undecided), the upper-limit task volume (upper-limit amount of manufacturing), and the amount-of-task monthly total (amount-of-manufacturing monthly total) may be included. In the breakdown, these amounts may be described in combination.

In the case of the amount-of-manufacturing display, various kinds of warning display in the process load chart 112 may be made if the amount of manufacturing or the total amount of manufacturing surpasses the upper-limit amount of manufacturing.

As another example of the display switching, various kinds of display in the process load chart 112 may be settable based on an option file. As settable factors, whether or not various kinds of items displayed in the process load chart 112 (for example, items of the breakdown area 114) are present, the unit of numerical values (for example, minute (M), hour (H), and so forth), the number of decimal places, the display position of numerical values or the like or whether or not the display is present, and so forth are cited, for example. In the setting of the display position, setting of the margin between stacked graphs of the total task graph 113 and so forth may be included.

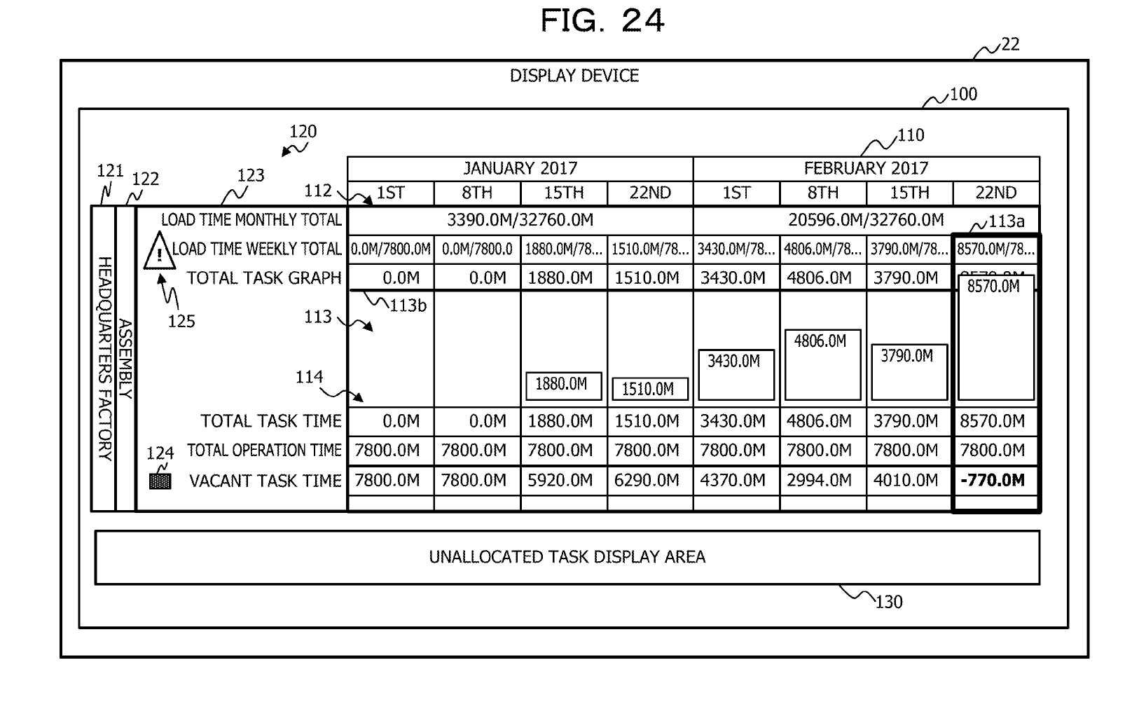

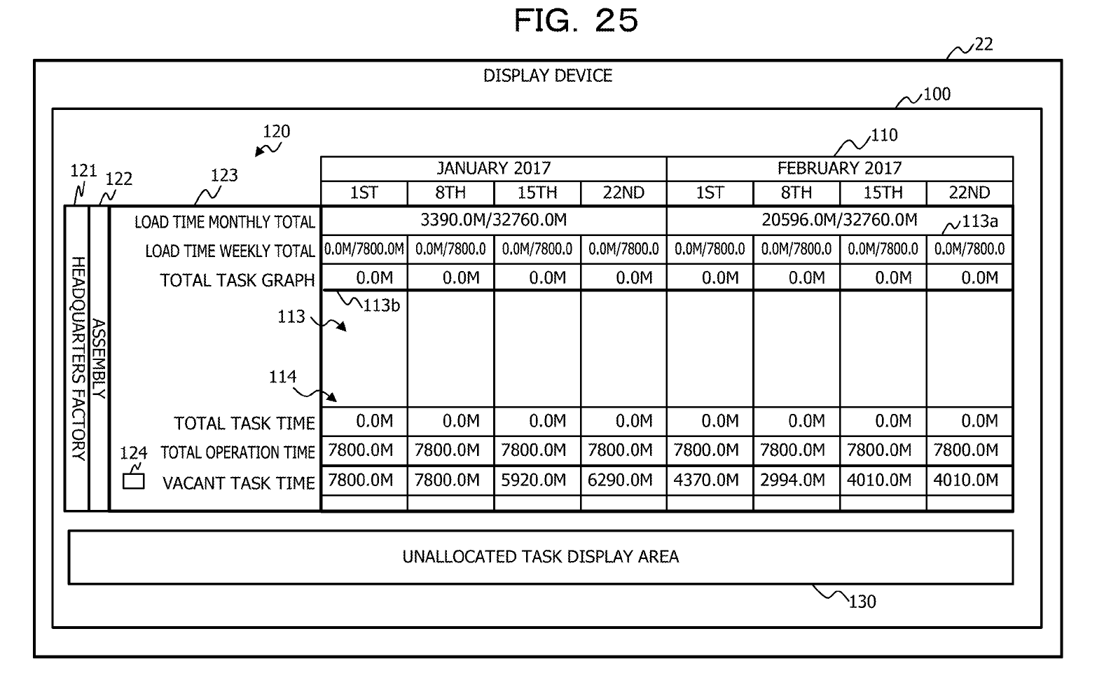

FIG. 24 and FIG. 25 are diagrams illustrating a display example of the display area 100 when various kinds of display in the process load chart 112 are changed from FIG. 15.

In the example of FIG. 24 and FIG. 25, the chart area 110 is displayed in terms of week as described later. Furthermore, in the process load chart 112, the unit of numerical values is set to the minute (M) and the numerical values are displayed to the first decimal place. Moreover, in the total task graph 113, the total task time is displayed at the upper part of the total task graph 113 and the upper-limit line 113b is displayed. Furthermore, the total task time, the total operation time, and the vacant task time are displayed in the breakdown area 114. Moreover, the display position of the warning display 125 has been changed in the line area 120.

In the example of FIG. 24, the case is represented in which the unallocated plan subject button 124 is valid by default from the initial state before allocation of date and time to tasks. For this reason, when the unallocated plan subject button 124 is made invalid, all items of the process load chart 112 (other than the total operation time and the vacant task time) become the initial value (for example, 0) as represented in FIG. 25. This is because the already-allocated task does not exist. In this case, in the state in which all tasks are unallocated, the operator may allocate date and time to the unallocated tasks by operation of the manufacturing plan list screen 150 described with reference to FIG. 18.

(Setting and Switching Example of Display Scale in Chart Area)

The display scale of the chart area 110 (for example, Gantt chart 111 and process load chart 112) may change according to the specific period such as “day,” “week,” or “month” as the unit of display of the load, for example.

Furthermore, the times or amounts displayed in the total task graph 113 and the breakdown area 114 may be tallied as “daily total,” “weekly total,” or “monthly total” according to the display scale of the process load chart 112. The basic clock time, the basic day of week, the monthly closing date, and so forth in the display of the graph may be settable as a plan rule. For example, the default values of the plan rule may be set as follows: basic clock time: “00:00,” basic day of week: “Sunday,” and monthly closing date: “month-end closing.”

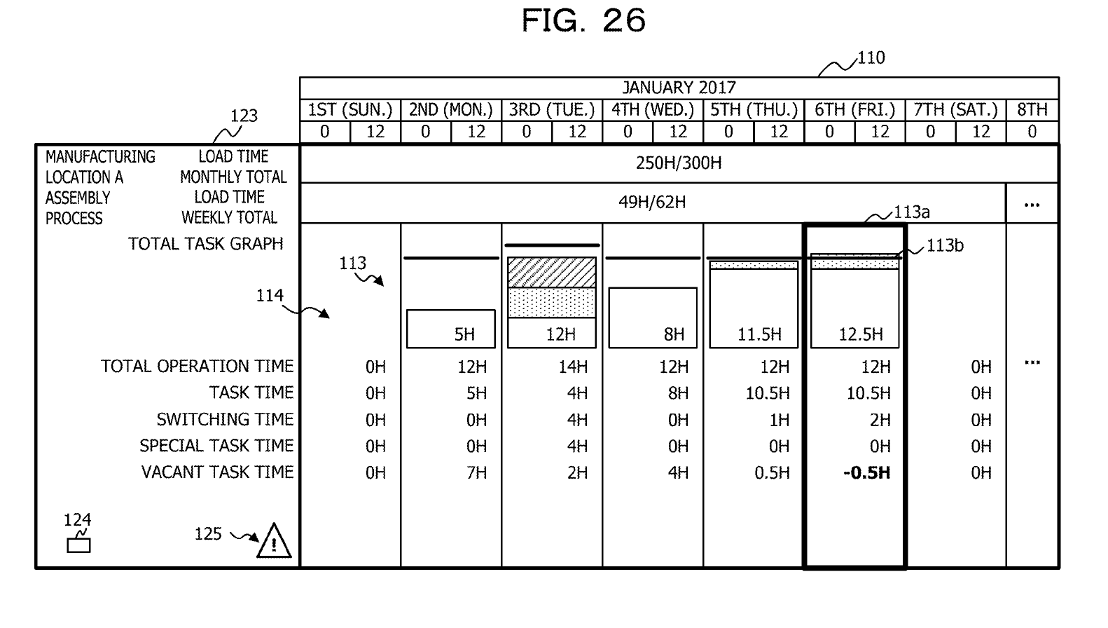

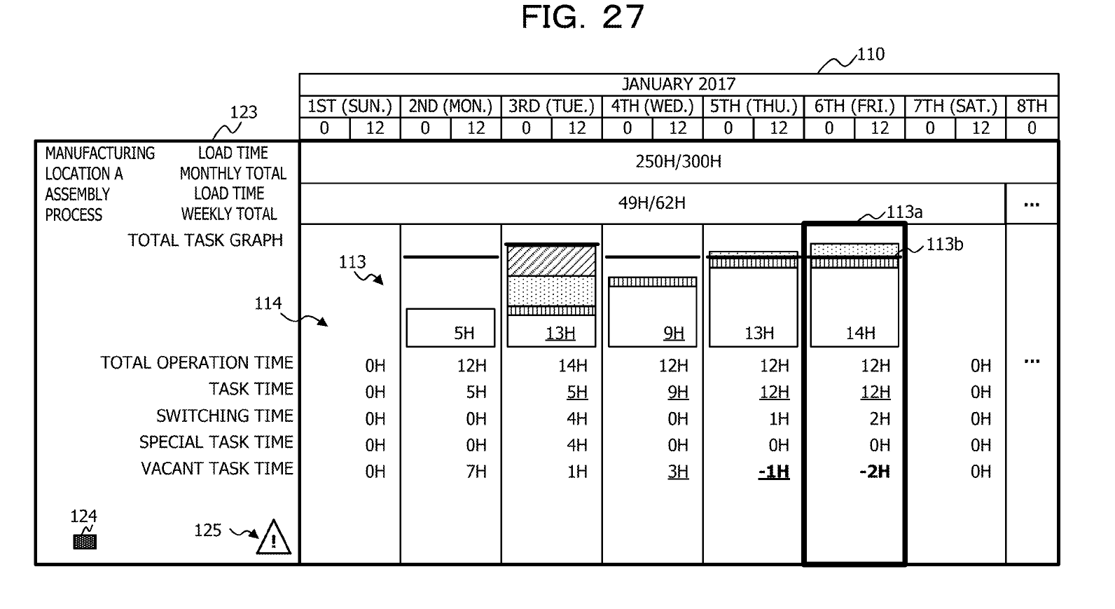

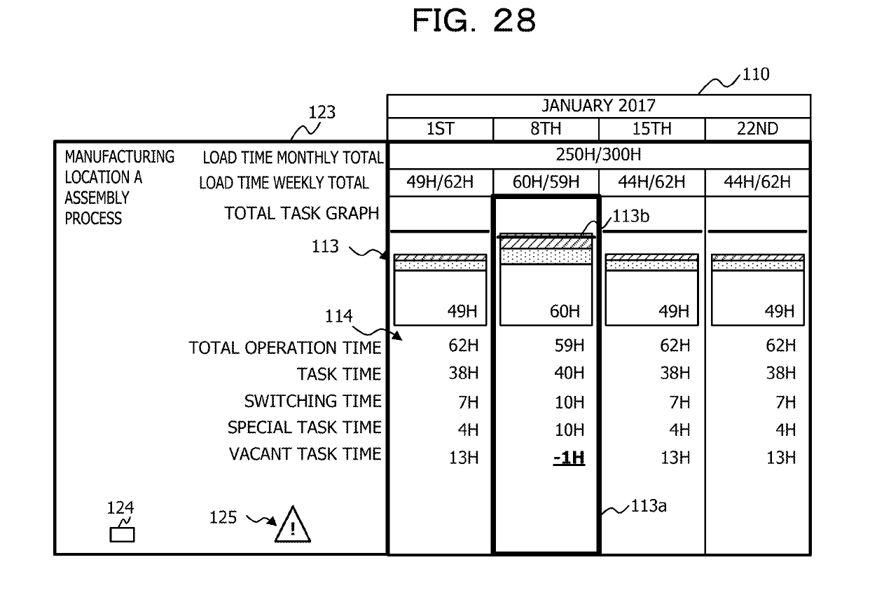

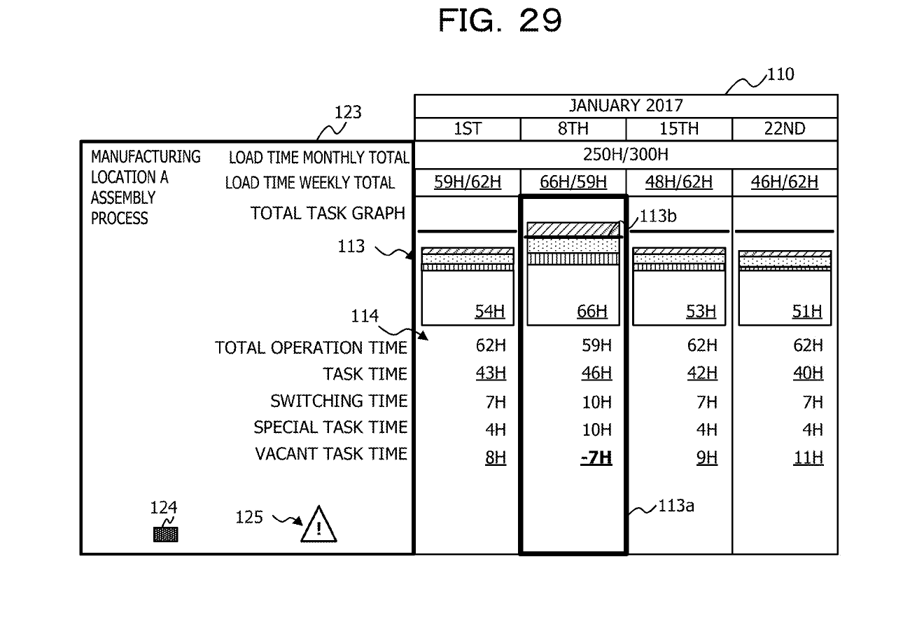

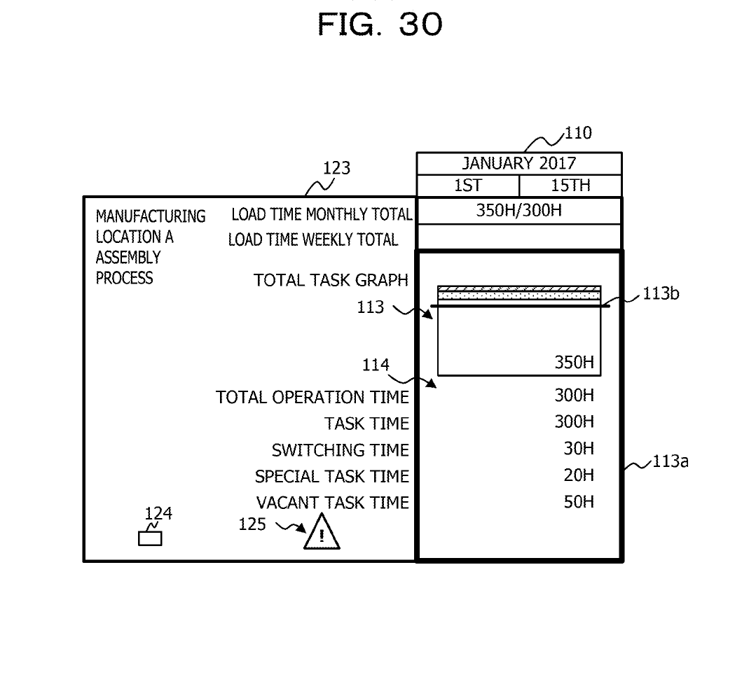

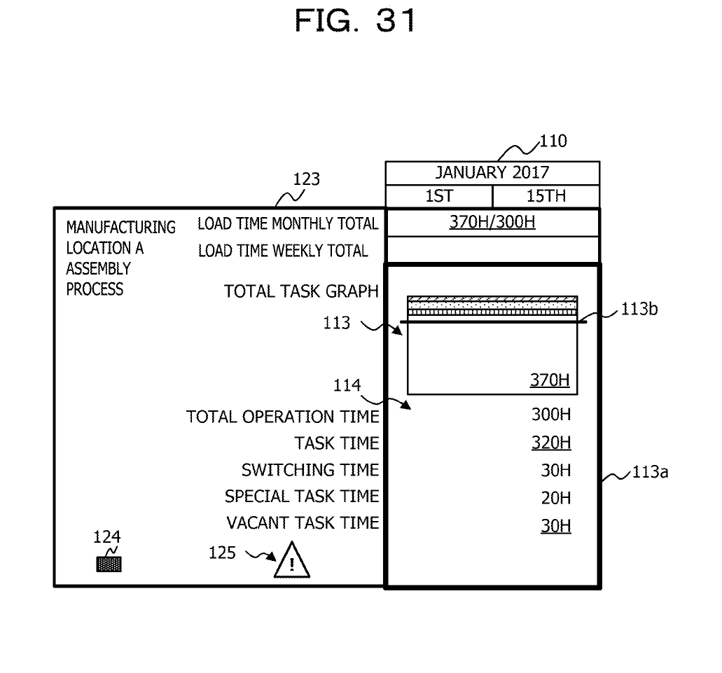

FIG. 26 to FIG. 31 are diagrams illustrating display examples of the process load chart 112 when the display scale of the chart area 110 is set to “day,” “week,” and “month.” FIG. 27, FIG. 29, and FIG. 31 represent display examples when the unallocated plan subject button 124 is pressed down in FIG. 26, FIG. 28, and FIG. 30, respectively.

As illustrated in FIG. 26 and FIG. 27, the example of the case in which the chart area 110 is displayed in terms of day is similar to the case described with reference to FIG. 15 and so forth. The start position of the weekly total area may be the date of the day of week set in the plan rule (for example, “Sunday” by default).

When the chart area 110 is displayed in terms of week (for example, displayed with intervals of seven days), the aggregates of the times (or amounts) of each week are displayed in the total task graph 113 and the breakdown area 114 as illustrated in FIG. 28 and FIG. 29. The dates displayed in the time area at the upper part of the chart area 110 (“1,” “8,” “15,” “22,” and so forth) may be dates of the day of week set in the plan rule (for example, “Sunday” by default).

When the chart area 110 is displayed in terms of month (for example, displayed with intervals of 15 days (or 30 days)), the aggregates of the times (or amounts) of each month are displayed in the total task graph 113 and the breakdown area 114 as illustrated in FIG. 30 and FIG. 31. The dates displayed in the time area at the upper part of the chart area 110 (“1,” “15,” and so forth) may be dates set in the plan rule (for example, “1” by default). Furthermore, in the case of the display in terms of month, the display of the weekly total of the total task (or weekly total of the amount of manufacturing) in the weekly total area may be inactivated.

In the description thus far, it is assumed that, in the chart area 110, the delimiting lines of the time area, the delimiting lines (section) of the monthly total area, the delimiting lines (section) of the weekly total area, and the delimiting lines (section) of the total task graph 113 and the breakdown area 114 are aligned with each other for convenience. However, in practice, these delimiting lines do not correspond with each other in most cases. Therefore, in the monthly total area, the weekly total area, and the total task graph 113 and the breakdown area 114, aggregates in accordance with a period set for each may be displayed.

### [1-5] Operation Example

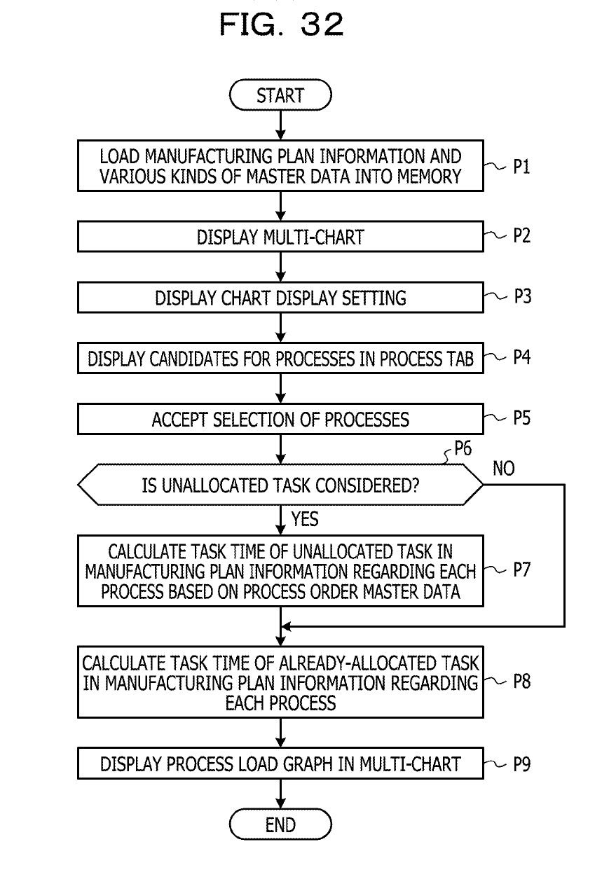

Next, an operation example of the server 10 in the system 1 configured as described above will be described with reference to FIG. 32.

As illustrated in FIG. 32, the display control unit 15 of the server 10 receives, from the operation accepting unit 13, an instruction according to a request for manufacturing plan creation from the terminal 20 and loads the manufacturing plan information 12a and various kinds of master data (11a to 11d and so forth) into the memory 10b (step P1).

Subsequently, the display control unit 15 causes the chart area 110 (for example, multi-chart) to be displayed in the display area 100 of the display device 22 (step P2; see FIG. 3) and causes the chart display setting screen 140 to be displayed according to operation of the pointer 101 (step P3; see FIG. 4).

In display control of the chart display setting screen 140, the display control unit 15 displays candidates for processes in the process tab (step P4; see FIG. 8) and accepts selection of processes by operation of the pointer 101 and pressing-down of the display button 146 (step P5; see FIG. 10).

In display control of the process load chart 112, the display control unit 15 determines whether or not to consider the unallocated task (step P6). For example, this determination may be carried out based on whether the unallocated plan subject button 124 is valid by default (or whether the unallocated plan subject button 124 was valid in the process load chart 112 displayed last) in an option file, or the like.

If the unallocated task is not considered (No in the step P6), the processing makes a transition to a step P8. On the other hand, if the unallocated task is considered (Yes in the step P6), the display control unit 15 calculates the task time of the unallocated task in the manufacturing plan information 12a regarding each process based on the process order master data 11d and so forth (step P7).

Subsequently, the display control unit 15 calculates the task time of the already-allocated task in the manufacturing plan information 12a regarding each process based on the line manufacturing procedure master data 11c and so forth (step P8).

Then, the display control unit 15 causes the process load chart 112 to be displayed in the chart area 110 (for example, multi-chart) based on the processing result of at least one of the step P7 and the step P8 (step P9), so that the processing ends. The process load chart 112 displayed in the step P9 may be the contents exemplified in FIG. 15 and FIG. 25 (case in which the unallocated task is not considered), the contents exemplified in FIG. 16 and FIG. 24 (case in which the unallocated task is considered), or the like.

### [2] Others

Techniques relating to the above-described one embodiment may be carried out with the following modifications and changes.

The functional blocks included in the server 10 illustrated in FIG. 1 may be consolidated based on various combinations or be divided.

Furthermore, functions of the server 10 may be implemented by a multi-processor or the processor 10a with a multi-core.

Moreover, the processing result by the display control unit 15 may be exported as data, for example. As one example, the output unit 14 or the display control unit 15 may have a function of exporting the total task graph 113 that is currently displayed as a graph in response to pressing-down of a specific button. Alternatively, the output unit 14 or the display control unit 15 may have a function of exporting information relating to already-allocated task and unallocated task as a file of comma-separated values (CSV) or the like in response to pressing-down of a specific button.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of creating, by a computer, a task plan that prescribes an execution time of a task on which a completion time limit is set, the method comprising:
allocating the execution time of at least one first task in a first period;
calculating a first total time length for execution of the at least one first task allocated in the first period;
identifying at least one second task that is not allocated in the first period and has the completion time limit set in the first period;
calculating a second total time length for execution of the at least one second task; and
displaying the first total time length and the second total time length on a display device.

2. The method according to claim 1, wherein
in the displaying the first total time length and the second total time length on the display device, a graph that represents the second total time is displayed on the display device with a graph that represents the first total time length.

3. The method according to claim 1, further comprising:
allocating the at least one first task to a manufacturing line,
wherein the first total time length is calculated based on a manufacturing capability of the manufacturing line.

4. The method according to claim 1, wherein
the first total time length is a standard time length associated with the at least one first task.

5. The method according to claim 4, further comprising:
deciding the execution time of the at least one first task based on the standard time length and the completion time limit of the at least one first task.

6. The method according to claim 2, further comprising:
calculating a third total time length for switching of the at least one first task; and
displaying a graph that represents the third total time length on the display device.

7. The method according to claim 6, further comprising:
displaying a graph that represents a fourth total time length obtained by summing up the first total time length, the second total time length and the third total time length on the display device.

8. An information processing apparatus configured to creating a task plan that prescribes an execution time of a task on which a completion time limit is set, the information processing apparatus comprising:
a memory; and
a processor coupled to the memory and configured to:
allocate the execution time of at least one first task in a first period,
calculate a first total time length for execution of the at least one first task allocated in the first period,
identify at least one second task that is not allocated in the first period and has the completion time limit set in the first period,
calculate a second total time length for execution of the at least one second task, and
display the first total time length and the second total time length on a display device.

9. The information processing apparatus according to claim 8, wherein
a graph that represents the second total time is displayed on the display device with a graph that represents the first total time length.

10. The information processing apparatus according to claim 8, wherein
the processor is configured to allocate the at least one first task to a manufacturing line,
wherein the first total time length is calculated based on a manufacturing capability of the manufacturing line.

11. The information processing apparatus according to claim 8, wherein
the first total time length is a standard time length associated with the at least one first task.

12. The information processing apparatus according to claim 11, wherein
the processor is configured to decide the execution time of the at least one first task based on the standard time length and the completion time limit of the at least one first task.

13. The information processing apparatus according to claim 9, wherein
the processor is configured to
calculate a third total time length for switching of the at least one first task, and
display a graph that represents the third total time length on the display device.

14. The information processing apparatus according to claim 13, wherein
the processor is configured to display a graph that represents a fourth total time length obtained by summing up the first total time length, the second total time length and the third total time length on the display device.

15. A non-transitory computer-readable storage medium storing a program that causes an information processing apparatus to execute a process for creating a task plan that prescribes an execution time of a task on which a completion time limit is set, the process comprising:
allocating the execution time of at least one first task in a first period;
calculating a first total time length for execution of the at least one first task allocated in the first period;
identifying at least one second task that is not allocated in the first period and has the completion time limit set in the first period;
calculating a second total time length for execution of the at least one second task; and
displaying the first total time length and the second total time length on a display device.

16. The non-transitory computer-readable storage medium according to claim 15, wherein
in the displaying the first total time length and the second total time length on the display device, a graph that represents the second total time is displayed on the display device with a graph that represents the first total time length.

17. The non-transitory computer-readable storage medium according to claim 15, the process further comprising:
allocating the at least one first task to a manufacturing line,
wherein the first total time length is calculated based on a manufacturing capability of the manufacturing line.

18. The non-transitory computer-readable storage medium according to claim 15, wherein
the first total time length is a standard time length associated with the at least one first task.

19. The non-transitory computer-readable storage medium according to claim 18, the process further comprising:
deciding the execution time of the at least one first task based on the standard time length and the completion time limit of the at least one first task.

20. The non-transitory computer-readable storage medium according to claim 16, the process further comprising:
calculating a third total time length for switching of the at least one first task; and
displaying a graph that represents the third total time length on the display device.
